(19) United States
(12) Patent Application Publication
(10) Pub. No.: US 2026/0082262 A1
(43) Pub. Date: Mar. 19, 2026

(54) TECHNIQUES FOR CSI-RS RESOURCE CONFIGURATION AND IMPLICIT MAPPING FOR LARGE-PORT CSI

(71) Applicant: Lenovo (United States) Inc., Morrisville, NC (US)

(72) Inventor: Khaled Nafez Rauf Ardah, Ilmenau (DE)

(21) Appl. No.: 19/401,211

(22) Filed: Nov. 25, 2025

(51) Int. Cl. H04W 24/10; H04B 7/06; H04L 5/00; H04W 24/08

(52) U.S. Cl. CPC H04W 24/10; H04B 7/0626; H04L 5/0048; H04W 24/08

(57) ABSTRACT

Various aspects of the present disclosure relate to techniques for communicating channel state information reference signal (CSI-RS) resource configuration and implicit mapping for large-port CSI. A user equipment is configured to receive a CSI-RS resource configuration that configures a CSI-RS resource associated with a quantity of CSI-RS ports greater than a threshold number of ports, identify at least one resource-element location based at least in part on a rule indicated in the CSI-RS resource configuration, wherein the CSI-RS resource configuration indicates fewer than all resource-element locations for the CSI-RS resource, perform one or more CSI measurements based on the identified at least one resource-element location, and transmit a CSI report comprising at least one of the CSI measurements.

### TECHNICAL FIELD

The present disclosure relates to wireless communications, and more specifically to techniques for communicating channel state information reference signal (CSI-RS) resource configuration and implicit mapping for large-port CSI.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE) and methods of the present disclosure each have several innovative aspects, no single one of which is solely responsible for the desirable features disclosed herein.

A UE for wireless communication is described. The UE may be configured to, capable of, or operable to receive a CSI-RS resource configuration that configures a CSI-RS resource associated with a quantity of CSI-RS ports greater than a threshold number of ports, identify at least one resource-element location based at least in part on a rule indicated in the CSI-RS resource configuration, wherein the CSI-RS resource configuration indicates fewer than all resource-element locations for the CSI-RS resource, perform one or more CSI measurements based on the identified at least one resource-element location, and transmit a CSI report comprising at least one of the CSI measurements.

A processor for wireless communication is described. The processor may be configured to, capable of, or operable to receive a CSI-RS resource configuration that configures a CSI-RS resource associated with a quantity of CSI-RS ports greater than a threshold number of ports, identify at least one resource-element location based at least in part on a rule indicated in the CSI-RS resource configuration, wherein the CSI-RS resource configuration indicates fewer than all resource-element locations for the CSI-RS resource, perform one or more CSI measurements based on the identified at least one resource-element location, and transmit a CSI report comprising at least one of the CSI measurements.

A method for wireless communication performed by a UE is described. The method may be configured to, capable of, or operable to receive a CSI-RS resource configuration that configures a CSI-RS resource associated with a quantity of CSI-RS ports greater than a threshold number of ports, identify at least one resource-element location based at least in part on a rule indicated in the CSI-RS resource configuration, wherein the CSI-RS resource configuration indicates fewer than all resource-element locations for the CSI-RS resource, perform one or more CSI measurements based on the identified at least one resource-element location, and transmit a CSI report comprising at least one of the CSI measurements.

An NE for wireless communication is described. The NE may be configured to, capable of, or operable to generate a CSI-RS resource configuration that configures a CSI-RS resource associated with a quantity of CSI-RS ports greater than a threshold number of ports, include, in the CSI-RS resource configuration, a rule for identifying at least one resource-element location for the CSI-RS resource, wherein the CSI-RS resource configuration indicates fewer than all resource-element locations for the CSI-RS resource, and transmit the CSI-RS resource configuration for performing CSI measurements based on the CSI-RS resource.

A processor for wireless communication is described. The processor may be configured to, capable of, or operable to generate a CSI-RS resource configuration that configures a CSI-RS resource associated with a quantity of CSI-RS ports greater than a threshold number of ports, include, in the CSI-RS resource configuration, a rule for identifying at least one resource-element location for the CSI-RS resource, wherein the CSI-RS resource configuration indicates fewer than all resource-element locations for the CSI-RS resource, and transmit the CSI-RS resource configuration for performing CSI measurements based on the CSI-RS resource.

A method for wireless communication performed by a NE is described. The method may be configured to, capable of, or operable to generate a CSI-RS resource configuration that configures a CSI-RS resource associated with a quantity of CSI-RS ports greater than a threshold number of ports, include, in the CSI-RS resource configuration, a rule for identifying at least one resource-element location for the CSI-RS resource, wherein the CSI-RS resource configuration indicates fewer than all resource-element locations for the CSI-RS resource, and transmit the CSI-RS resource configuration for performing CSI measurements based on the CSI-RS resource.

### BRIEF DESCRIPTION OF THE DRAWINGS

FIG. 1 illustrates an example of a wireless communications system in accordance with aspects of the present disclosure.

FIG. 2A depicts one example of a CSI-RS configuration table in accordance with aspects of the present disclosure.

FIG. 2B depicts one example of a CSI-RS configuration table in accordance with aspects of the present disclosure.

FIG. 3 illustrates an example of a CSI-RS resource with a configured offset according to aspects of the present disclosure.

FIG. 4 illustrates an example representation of a CSI-RS resource in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

Multi-antenna wireless communication systems, such as those specified for 5G New Radio (NR) and under study for 6G systems, rely on accurate downlink channel state information (CSI) to support advanced beamforming, spatial multiplexing, link adaptation, and coverage enhancements. CSI-RS provide the downlink reference structure—that is, the time-frequency resource-element pattern, port structure, and associated reference-signal sequence—used by a UE to estimate CSI and report it to a network node (e.g., a base station or next-generation NodeB (gNB)).

In NR, CSI-RS resources are configured according to one or more tables that explicitly define CSI-RS port configurations. In some instances, these tables may only define CSI-RS port configurations up to a limited number of antenna ports (e.g., up to 32 ports). When a network requires a larger number of CSI-RS ports—such as 48, 64, 128, or more—the current NR framework may rely on resource aggregation, where multiple smaller CSI-RS resources are grouped to emulate a larger CSI-RS resource. While aggregation allows for compatibility, it introduces signaling overhead, reduces configuration flexibility, and increases complexity at both the UE and the network side.

As systems advance toward 6G, base stations are expected to support substantially larger antenna arrays, possibly comprising 128, 256, 512, or more antenna ports. Under current specifications, supporting CSI-RS configurations with such large port counts may require aggregating many smaller CSI-RS resources, leading to excessive overhead and limiting the system's ability to efficiently map reference signals across time and frequency. In addition, NR provides limited support for flexible mapping of resource elements (REs) across multiple resource blocks (RBs) or slots when dealing with high-port-count CSI-RS resources.

Thus, there exists a need for more scalable CSI-RS configuration mechanisms that can support CSI-RS resources having a large number of ports without depending solely on resource aggregation and without requiring explicit signaling of all resource-element locations. Furthermore, there is a need for improved mechanisms enabling a UE to derive unspecified portions of a CSI-RS resource based on compact signaling, offsets, rules, or mapping patterns.

In one example, a UE is configured to receive a CSI-RS resource configuration that directly specifies a CSI-RS resource associated with a quantity of CSI-RS ports greater than a threshold number of ports. The threshold may correspond to the maximum number of ports directly defined in a reference configuration table (e.g., 32 ports in NR). By enabling a CSI-RS resource to be configured natively with more than the threshold number of ports, aggregation may be reduced or avoided, thereby improving flexibility and signaling efficiency.

In some implementations, the UE determines at least a portion of the resource-element locations for the CSI-RS resource based on one or more parameters included in the CSI-RS resource configuration. These parameters may include, for example, one or more of: a time-domain allocation, a frequency-domain allocation, a density indication, or a code-domain multiplexing (CDM) type. In certain examples, the configuration indicates fewer than all of the RE locations associated with the CSI-RS resource. Accordingly, the UE may identify or derive additional RE locations based on a rule, offset, or mapping-type indicator included in the configuration. For instance, in one example, a rule may specify an offset in the time domain or frequency domain relative to an explicitly provided anchor RE location, or may specify an inter-CDM-group separation or density.

In another example, a NE generates and transmits a CSI-RS resource configuration that includes one or more rules for deriving RE locations for a multi-port CSI-RS resource. The NE may explicitly define only a portion of the resource-element mapping for the CSI-RS resource and may include one or more derivation parameters—such as a frequency offset, time offset, or mapping-type indicator—to allow the UE to implicitly determine the remaining RE locations. This approach may reduce signaling overhead and facilitate flexible mapping of large-port CSI-RS resources across multiple RBs or slots.

Collectively, these techniques provide improved support for CSI-RS resources with large port counts and enable scalable RE-mapping behavior for next-generation multi-antenna systems.

Aspects of the present disclosure are described in the context of a wireless communications system. Note that one or more aspects from different solutions may be combined.

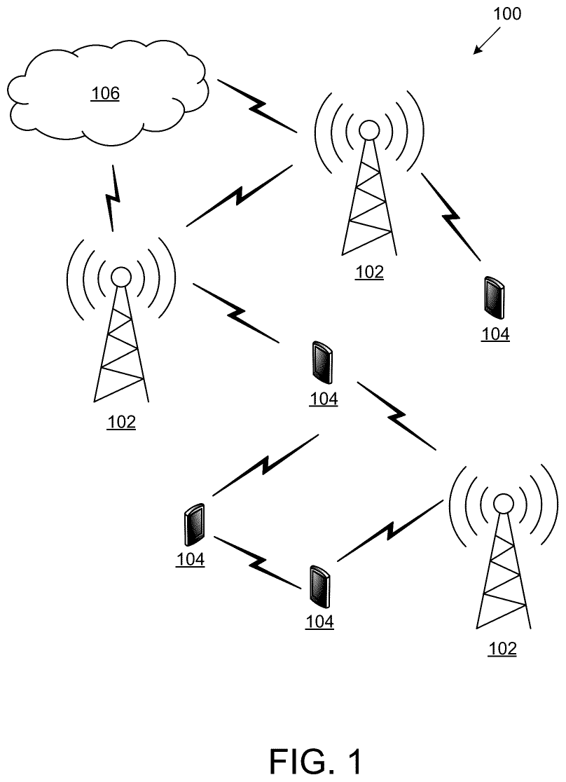

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a gNB, or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHZ-52.6 GHz), FR3 (7.125 GHZ-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one example, with reference to FIG. 1, the NE 102 may transmit a CSI-RS resource configuration to the UE 104, where the configuration specifies a CSI-RS resource associated with a quantity of CSI-RS ports greater than a threshold number of ports natively supported by legacy configuration tables. Because the NE 102 may indicate fewer than all resource-element locations for the CSI-RS resource, the UE 104 may identify or derive additional resource-element locations based at least in part on a rule, offset, or mapping parameter included in the configuration. In certain implementations, the UE 104 may then perform CSI measurements based on the identified resource-element locations and provide a CSI report back to the NE 102. The combination of signaling from the NE 102 and implicit derivation at the UE 104 enables flexible and scalable CSI-RS resource configuration within system 100, including support for large-port CSI-RS resources that may be utilized in advanced multi-antenna deployments in 5G, 5G-Advanced, or 6G systems.

In one example, CSI-RS resource configurations and specifications are defined in various third generation partnership project (3GPP) technical specifications, including 3GPP technical specification (TS) 38.211, 3GPP TS 38.214, and 3GPP TS 38.331 (all incorporated herein by reference). In NR, CSI-RS resources may be configured for a UE to enable CSI estimation, which may be used for, for example, beamforming, link adaptation, and other advanced multi-antenna techniques.

According to 3GPP TS 38.214, clause 5.2.2.3, a UE may be configured with one or more non-zero-power (NZP) CSI-RS resource set configurations via higher-layer parameters such as CSI-ResourceConfig and NZP-CSI-RS-ResourceSet. Each NZP CSI-RS resource set may include one or more NZP CSI-RS resources. For each CSI-RS resource configuration, the UE receives a variety of signaled, based on which the UE may assume non-zero transmission power for the CSI-RS. These parameters may include a CSI-RS resource identity (NZP-CSI-RS-ResourceId) and a periodicity and slot offset (periodicityAndOffset) that define the periodic or semi-persistent transmission occasions for the CSI-RS. In some examples, all CSI-RS resources within a set share a common periodicity, although the slot offset may be the same or different among the resources.

The configuration may also include a resource-mapping parameter (resourceMapping) that defines characteristics such as the number of CSI-RS ports, the applicable CDM type, and the OFDM symbol and subcarrier occupancy of the CSI-RS resource within a slot. Clause 7.4.1.5 of TS 38.211 may provide the allowed values for these parameters. A related parameter (e.g., nrofPorts) may indicate the number of CSI-RS ports, while a density parameter (e.g., density) may define the CSI-RS frequency density per physical resource block (PRB), and when applicable, a PRB offset, for example when the density value is ½. For such cases, odd/even PRB allocation may be specified relative to the common resource-block grid.

Additional parameters may include the CDM pattern (e.g., cdm-Type), which may specify CDM types such as noCDM, fd-CDM2, or CDM patterns involving multiple time/frequency dimensions. Power-control-related parameters may further be provided, including a powerControlOffset that may specify a ratio of physical downlink shared channel (PDSCH) energy per resource element (EPRE) to NZP CSI-RS EPRE used for CSI derivation, and a powerControlOffsetSS that may specify a ratio of NZP CSI-RS EPRE to synchronization signal (SS)/physical broadcast channel (PBCH) EPRE. The configuration may also include a scrambling identifier (scramblingID) for CSI-RS sequence generation and a bandwidth-part identifier (BWP-Id) specifying the BWP within which the CSI-RS is located.

A repetition parameter (e.g., repetition) associated with an NZP CSI-RS resource set may indicate whether the UE can assume that CSI-RS resources in the set are transmitted using the same downlink spatial-domain transmission filter, depending on certain reporting configurations. The configuration may further include quasi-co-location (QCL) information (qcl-InfoPeriodicCSI-RS) referencing a transmission configuration indication (TCI) state that identifies QCL source reference signals and QCL types. The referenced RS may be, for example, an SS/PBCH block or another CSI-RS resource located in the same or a different carrier or bandwidth part. Tracking-reference-signal information (trs-Info) may also be associated with a resource set and may allow the UE to assume that antenna ports with the same index across configured NZP CSI-RS resources correspond to the same physical antenna configuration under certain conditions.

In general, for an NZP CSI-RS resource set used for channel measurement, CSI-RS resources within the set are typically configured with the same density and the same number of ports, although certain exceptions may apply, such as for interference-measurement resources or when density ½ is used with specific reporting and codebook types. A UE may additionally expect that all CSI-RS resources in a resource set share a common starting RB, a common number of RBs, and a common CDM type. For CSI-RS sets linked to specific CSI-ReportConfig instances, the UE may further expect consistent QCL information, power-control offsets, and related parameters across all resources in the set.

In some examples, the slot offsets between CSI-RS resources within a resource set for channel measurement may be constrained to a limited number of slots, such as within one or two slots, without any downlink/uplink switching between the respective CSI-RS transmissions. Such constraints may apply for certain reporting configurations and codebook types.

In one example, e.g., according to 3GPP TS 38.211, clause 7.4.1.5, the bandwidth and initial common resource block (CRB) index of a CSI-RS resource in a bandwidth part (BWP) is determined based on higher-layer parameters such as nrofRBs and startingRB within a CSI-FrequencyOccupation information element (IE). Both nrofRBs and startingRB are configured as integer multiples of 4 RBs, with the reference point for startingRB being CRB 0 on the common resource block grid. Based on the relative position of startingRB to the BWP start index and the configured BWP size, the UE may derive the initial CRB index and the effective CSI-RS bandwidth. In general, the resulting CSI-RS bandwidth is constrained by the BWP size, and a minimum CSI-RS bandwidth (e.g., at least a certain number of RBs) may be assumed.

In one example, e.g., according to 3GPP TS 38.211, clause 7.4.1.5, ZP CSI-RS and NZP CSI-RS are distinguishable. For NZP CSI-RS, the sequence is generated according to a sequence generation clause (e.g., clause 7.4.1.5.2) and mapped to resource elements according to a resource mapping clause (e.g., clause 7.4.1.5.3). For ZP CSI-RS, the UE generally assumes that the specified resource elements are reserved (e.g., not used for PDSCH), but the UE may still perform reception and measurement on other channels or signals that overlap ZP CSI-RS REs.

In one example, the UE may initialize a pseudo-random sequence generator based on parameters such as a slot index within a radio frame, an OFDM symbol index within the slot, and a scrambling identifier (e.g., scramblingID or sequenceGenerationConfig). The UE may map the resulting sequence to CSI-RS REs within one or more RBs and symbols according to parameters including density (p), the number of ports per resource (N), and a port mapping method.

The UE or the network may denote the total number of CSI-RS ports for a configured CSI-RS resource or set of resources by N_tot. For certain values (for example, N_tot in {1, 2, 4, 8, 12, 16, 24, 32}), the UE or the network may configure a single CSI-RS resource with N ports. For larger values (for example, N_tot in {48, 64, 128}), the UE or the network may configure a CSI-RS resource by aggregating K CSI-RS resources, each with N ports, such that N_tot=K·N. The possible combinations of N_tot, K, and N may be specified in a table such as Table 7.4.1.5.3-6 of TS 38.211. In such cases, the UE or the network may assign a resource index q to identify the position of each CSI-RS resource within the aggregated CSI-RS resource.

The mapping of CSI-RS sequences to REs is further characterized by CDM groups. For each row of a CSI-RS configuration table (e.g., Table 7.4.1.5.3-1), the CDM group size (e.g., 1, 2, 4, or 8), the time-domain anchor symbol locations (e.g., 10, 11), and the frequency-domain offsets (e.g., k0, k1, . . . ) may be defined. A CDM type (e.g., noCDM, fd-CDM2, cdm4-FD2-TD2, cdm8-FD2-TD4) determines the underlying orthogonal sequences applied in time and/or frequency to distinguish ports within a CDM group. Corresponding sequence values may be specified, for example, in tables such as Table 7.4.1.5.3-2 through Table 7.4.1.5.3-5.

TABLE 7.4.1.5.3-1
CSI-RS locations within a slot

| | Ports | Density | | | CDM group | | |
|---|---|---|---|---|---|---|---|
| Row | N | ρ | cdm-Type | (k̅_{q}, l̅_{q}) | index^{j} | k_{q}′ | l_{q}′ |
| 1 | 1 | 3 | noCDM | (k₀, l₀), (k₀ + 4, l₀), | 0, 0, 0 | 0 | 0 |
| | | | | (k₀ + 8, l₀) | | | |
| 2 | 1 | 1, 0.5 | noCDM | (k₀, l₀), | 0 | 0 | 0 |
| 3 | 2 | 1, 0.5 | fd-CDM2 | (k₀, l₀), | 0 | 0, 1 | 0 |
| 4 | 4 | 1 | fd-CDM2 | (k₀, l₀), (k₀ + 2, l₀) | 0, 1 | 0, 1 | 0 |
| 5 | 4 | 1 | fd-CDM2 | (k₀, l₀), (k₀, l₀ + 1) | 0, 1 | 0, 1 | 0 |
| 6 | 8 | 1 | fd-CDM2 | (k₀, l₀), (k₁, l₀), (k₂, l₀), | 0, 1, 2, 3 | 0, 1 | 0 |
| | | | | (k₃, l₀) | | | |
| 7 | 8 | 1 | fd-CDM2 | (k₀, l₀), (k₁, l₀), (k₀, l₀ + 1), | 0, 1, 2, 3 | 0, 1 | 0 |
| | | | | (k₁, l₀ + 1) | | | |
| 8 | 8 | 1 | cdm4-FD2-TD2 | (k₀, l₀), (k₁, l₀) | 0, 1 | 0, 1 | 0, 1 |
| 9 | 12 | 1 | fd-CDM2 | (k₀, l₀), (k₁, l₀), (k₂, l₀), | 0, 1, 2, 3, | 0, 1 | 0 |
| | | | | (k₃, l₀), (k₄, l₀), (k₅, l₀) | 4, 5 | | |
| 10 | 12 | 1 | cdm4-FD2-TD2 | (k₀, l₀), (k₁, l₀), (k₂, l₀) | 0, 1, 2 | 0, 1 | 0, 1 |
| 11 | 16 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), | 4, 5, 6, 7 | | |
| | | | | (k₁, l₀ + 1), (k₂, l₀ + 1), | | | |
| | | | | (k₃, l₀ + 1) | | | |
| 12 | 16 | 1, 0.5 | cdm4-FD2-TD2 | (k₀, l₀), (k₁, l₀), (k₂, l₀), | 0, 1, 2, 3 | 0, 1 | 0, 1 |
| | | | | (k₃, l₀) | | | |
| 13 | 24 | 1, 0.5 | fd-CDM2 | (k₀, l₀), (k₁, l₀), (k₂, l₀), | 0, 1, 2, 3, | 0, 1 | 0 |
| | | | | (k₀, l₀ + 1), (k₁, l₀ + 1), | 4, 5, 6, 7, | | |
| | | | | (k₂, l₀ + 1), (k₀, l₁), | 8, 9, 10, 11 | | |
| | | | | (k₁, l₁), (k₂, l₁), (k₀, l₁ + 1), | | | |
| | | | | (k₁, l₁ + 1), (k₂, l₁ + 1) | | | |
| 14 | 24 | 1, 0.5 | cdm4-FD2-TD2 | (k₀, l₀), (k₁, l₀), (k₂, l₀), | 0, 1, 2, 3, | 0, 1 | 0, 1 |
| | | | | (k₀, l₁), (k₁, l₁), (k₂, l₁) | 4, 5 | | |
| 15 | 24 | 1, 0.5 | cdm8-FD2-TD4 | (k₀, l₀), (k₁, l₀), (k₂, l₀) | 0, 1, 2 | 0, 1 | 0, 1, 2, 3 |
| 16 | 32 | 1, 0.5 | fd-CDM2 | (k₀, l₀), (k₁, l₀), (k₂, l₀), | 0, 1, 2, 3, | 0, 1 | 0 |
| | | | | (k₃, l₀), (k₀, l₀ + 1), | 4, 5, 6, 7, | | |
| | | | | (k₁, l₀ + 1), (k₂, l₀ + 1), | 8, 9, 10, 11, | | |
| | | | | (k₃, l₀ + 1), (k₀, l₁), | 12, 13, 14, 15 | | |
| | | | | (k₁, l₁), (k₂, l₁), (k₃, l₁), | | | |
| | | | | (k₀, l₁ + 1), (k₁, l₁ + 1), | | | |
| | | | | (k₂, l₁ + 1), (k₃, l₁ + 1) | | | |
| 17 | 32 | 1, 0.5 | cdm4-FD2-TD2 | (k₀, l₀), (k₁, l₀), (k₂, l₀), | 0, 1, 2, 3, | 0, 1 | 0, 1 |
| | | | | (k₃, l₀), (k₀, l₁), (k₁, l₁), | 4, 5, 6, 7 | | |
| | | | | (k₂, l₁), (k₃, l₁) | | | |
| 18 | 32 | 1, 0.5 | cdm8-FD2-TD4 | (k₀, l₀), (k₁, l₀), (k₂, l₀), | 0, 1, 2, 3 | 0, 1 | 0, 1, 2, 3 |
| | | | | (k₃, l₀) | | | |

TABLE 7.4.1.5.3-2
The sequences w_{f}(k_{q}^{′}) and wₜ(l_{q}^{′}) for cdm-Type equal to ‘noCDM’

| Index | w_{f}(0) | wₜ(0) |
|---|---|---|
| 0 | 1 | 1 |

TABLE 7.4.1.5.3-3
The sequences w_{f}(k_{q}^{′}) and wₜ(l_{q}^{′}) for cdm-Type equal to ‘fd-CDM2’

| Index | [w_{f}(0) w_{f}(1)] | wₜ(0) |
|---|---|---|
| 0 | [+1 +1] | 1 |
| 1 | [+1 −1] | 1 |

TABLE 7.4.1.5.3-4
The sequences w_{f}(k_{q}^{′}) and wₜ(l_{q}^{′})
for cdm-Type equal to ‘cdm4-FD2-TD2’

| Index | [w_{f}(0) w_{f}(1)] | [wₜ(0) wₜ(1)] |
|---|---|---|
| 0 | [+1 +1] | [+1 +1] |
| 1 | [+1 −1] | [+1 +1] |
| 2 | [+1 +1] | [+1 −1] |
| 3 | [+1 −1] | [+1 −1] |

TABLE 7.4.1.5.3-5
The sequences w_{f}(k_{q}′) and wₜ(l_{q}′)
for cdm-Type equal to ‘cdm8-FD2-TD4’

| Index | [w_{f}(0) w_{f}(1)] | [wₜ(0) wₜ(1) wₜ(2) wₜ(3)] |
|---|---|---|
| 0 | [+1 +1] | [+1 +1 +1 +1] |
| 1 | [+1 −1] | [+1 +1 +1 +1] |
| 2 | [+1 +1] | [+1 −1 +1 −1] |
| 3 | [+1 −1] | [+1 −1 +1 −1] |
| 4 | [+1 +1] | [+1 +1 −1 −1] |
| 5 | [+1 −1] | [+1 +1 −1 −1] |
| 6 | [+1 +1] | [+1 −1 −1 +1] |
| 7 | [+1 −1] | [+1 −1 −1 +1] |

TABLE 7.4.1.5.3-6
The supported combinations of Nₜₒₜ, K, and N when
the number of CSI-RS ports is 48, 64, or 128

| Nₜₒₜ | K | N |
|---|---|---|
| 48 | 2 | 24 |
| 48 | 3 | 16 |
| 64 | 4 | 16 |
| 64 | 2 | 32 |
| 128 | 4 | 32 |

In some examples, the time-domain locations (e.g., first and second OFDM symbols for CSI-RS within a slot) are provided via higher-layer parameters such as firstOFDMSymbol InTimeDomain and firstOFDMSymbolInTimeDomain2. Frequency-domain locations may be derived from a frequency-domain allocation bitmap, as provided by higher-layer parameters such as frequencyDomainAllocation, together with the configured density and bandwidth.

The CSI-RS ports used to transmit a CSI-RS resource may be numbered according to a base offset and a port index, where the specific mapping may depend on whether the total number of ports corresponds to a single resource or an aggregated resource, and may further depend on a port mapping method (e.g., a first or second method defined in the standard). Within a given row of a CSI-RS configuration table, a CDM group index may correspond to specific time/frequency positions, and the CDM groups may be ordered first in frequency and then in time.

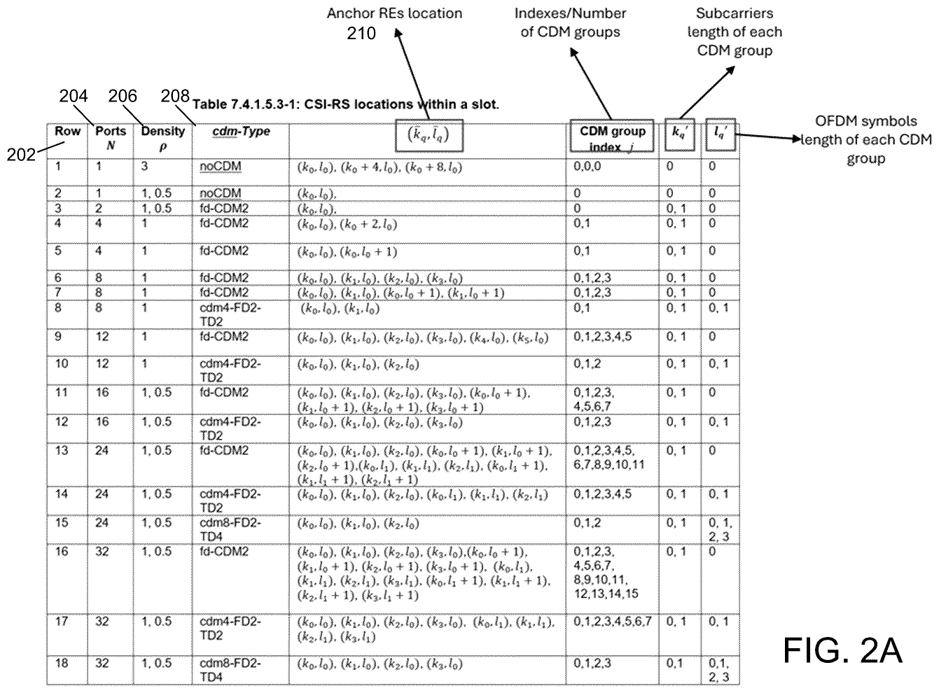

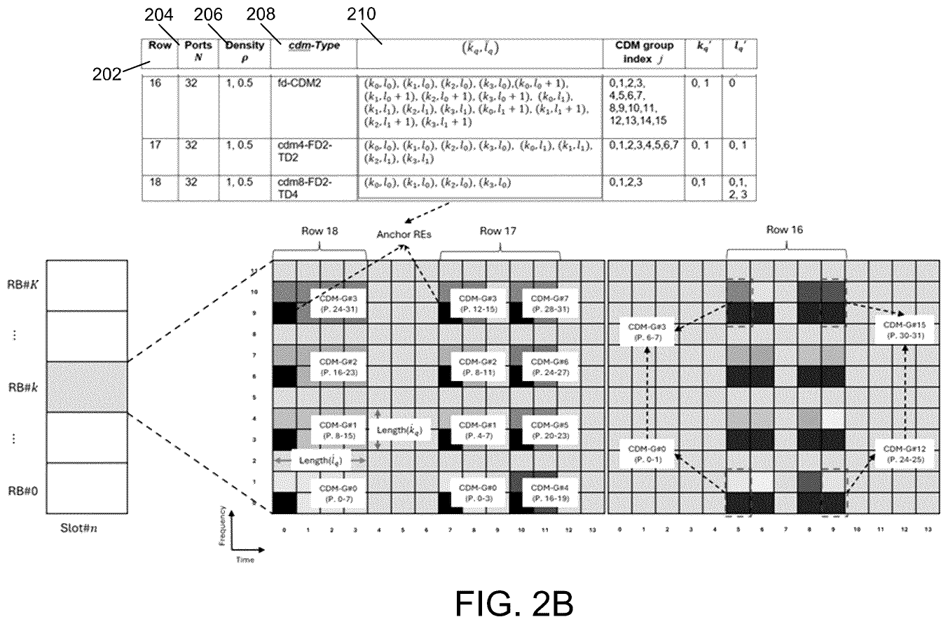

For instance, table 7.4.1.5.3-1 in TS 38.211, shown in FIG. 2A, provides example CSI-RS configurations within a slot, including, for each row 202, the number of ports N 204, allowable density values 206, the CDM type 208, and a set of time/frequency anchor locations 210 for each CDM group. For rows associated with 32 ports (for example, rows 16-18), shown in FIG. 2B, different time/frequency patterns may result in different distributions of REs among CDM groups.

In one example, CSI-RS ports may be partitioned into L CDM groups, each with N/L ports. For each CDM group, a corresponding set of REs may be defined by an anchor location, a frequency span, and a time span, such that the number of REs per CDM group equals the number of ports per CDM group. In such configurations, the overall RE usage within an RB and slot increases roughly linearly with the number of CSI-RS ports.

The density parameter may control the distribution of CSI-RS across RBs. For instance, a density of 1 may imply CSI-RS mapping on every RB within a configured set of RBs, while a density of ½ may imply mapping on every other RB. As a result, the fraction of total REs in a slot occupied by CSI-RS may scale with both the number of ports and the density. Reducing density (e.g., from 1 to ½ or lower) may reduce CSI-RS overhead proportionally.

In some NR specifications (e.g., TS 38.211), CSI-RS resources with larger numbers of ports (such as 48, 64, or 128 ports) are supported through aggregation of multiple CSI-RS resources with smaller numbers of ports. For example, Table 7.4.1.5.3-6 provides combinations of total ports N_tot, aggregation factor K, and per-resource ports N. For a total of 64 ports, one configuration may aggregate four resources of 16 ports each, while another configuration may aggregate two resources of 32 ports each.

When aggregating two 32-port CSI-RS resources to form a 64-port CSI-RS resource, different multiplexing schemes may be employed. In one example, a time-division multiplexing (TDM) scheme may be used, in which the two 32-port CSI-RS resources are assigned different time-domain positions (e.g., symbol indices) so that their REs do not overlap, without imposing specific density constraints beyond those already configured. In another example, a frequency-division multiplexing (FDM) scheme may be used, in which the two 32-port resources are placed on different RB subsets (for example, even versus odd RBs) using a density less than one (e.g., density ½). In such FDM configurations, additional constraints on the density and RB allocation may be required to avoid overlapping REs. These legacy aggregation approaches allow support for larger-port CSI-RS resources but may introduce additional configuration complexity and overhead.

As wireless systems evolve toward deployments with increasingly large antenna arrays, the reliance on CSI-RS aggregation to support CSI-RS resources with more than 32 ports becomes progressively inefficient. The legacy mechanisms for forming larger-port CSI-RS resources—such as aggregating multiple 16-port or 32-port CSI-RS resources using time-division or frequency-division multiplexing—can significantly increase configuration overhead, impose additional constraints on density and RB allocation, and reduce flexibility in CSI-RS mapping. These limitations may become more pronounced in future systems (e.g., 5G-Advanced or 6G) where CSI-RS resources may need to support 64, 128, or even larger quantities of ports. Accordingly, there is a need for improved CSI-RS resource configuration techniques capable of supporting CSI-RS resources with more than 32 ports while reducing or avoiding the increase in signaling or mapping overhead associated with resource aggregation. The techniques described in this disclosure address these challenges by enabling more scalable, flexible, and efficient CSI-RS configuration for large-port CSI-RS resources.

In one example embodiment, the UE or the network may configure the UE with one or more CSI-RS resource set configurations, where each CSI-RS resource set includes one or more CSI-RS resources, and each CSI-RS resource is associated with a CSI-RS resource-mapping configuration message that defines how the resource elements (REs) of the CSI-RS resource are mapped in the time and frequency domains within one or more slots. The CSI-RS resource-mapping configuration message may include a variety of parameters. In some examples, the configuration message may specify a row index identifying a corresponding row in a CSI-RS configuration table, such as Table 7.4.1.5.3-1 of TS 38.211 or an extended or enhanced version of such a table.

The configuration message may also include an indication of the number of CSI-RS ports N, which may take values such as 1, 2, 4, 8, 16, 24, 32, 48, 64, 128, 256, or 512. The configuration message may further identify a CDM type, such as noCDM, fd-CDM2, cdm4-FD2-TD2, cdm8-FD2-TD4, cdm16-FD2-TD8, cdm16-FD4-TD4, cdm32-FD4-TD8, or cdm64-FD8-TD8. In addition, the configuration message may include one or more frequency-domain allocations, for example indicated through one or more bitmaps, that configure the frequency-domain anchor-RE locations for one or more CDM groups, as well as one or more time-domain allocations that may similarly configure the time-domain anchor-RE locations for the CDM groups. The configuration message may also include a density value ρ, which may govern the mapping of CSI-RS across resource blocks, and may further include a CSI-RS frequency-allocation configuration, such as a starting resource block and a length or number of resource blocks, that together determine the resource-block region over which the associated CSI-RS resource is mapped.

In some examples, Table 7.4.1.5.3-1 of 3GPP TS 38.211 may be extended by introducing one or more additional rows (for example, a row indexed as 19) that configure a CSI-RS resource associated with a number of ports greater than thirty-two. Such an extended row may support CSI-RS port quantities of, for example, 48, 64, 128, 256, or 512 ports. In these embodiments, the extended row may further specify a CDM type selected from among fd-CDM2, cdm4-FD2-TD2, cdm8-FD2-TD4, cdm16-FD2-TD8, cdm16-FD4-TD4, cdm32-FD4-TD8, or cdm64-FD8-TD8. Exemplary additional rows of this type are shown in Tables 1 through 22, and corresponding time-domain and frequency-domain CDM sequences w_{f}(k_{q}′) and wₜ(l_{q}′) for the CDM types cdm16-FD2-TD8, cdm16-FD4-TD4, cdm32-FD4-TD8, and cdm64-FD8-TD8 are provided below.

By way of example, an extended version of Table 7.4.1.5.3-1 may include a new row defining a CSI-RS resource with N=48 ports and a CDM type of fd-CDM2. In this case, the UE or the network may partition the CSI-RS resource into twenty-four CDM groups indexed from 0 to 23, as illustrated, for instance, in row indices 1, 2, or 3 of Table 1. In another example, the UE or the network may extend Table 7.4.1.5.3-1 to include a row defining a CSI-RS resource with N=48 ports and a CDM type of cdm16-FD2-TD8, in which case the CSI-RS resource may include three CDM groups indexed as {0, 1, 2}, as shown, for example, in row index 1 of Table 7. Similar extensions may be defined for other port quantities and CDM types, as illustrated in the accompanying tables.

In one example, at least one additional row is incorporated into Table 7.4.1.5.3-1 of TS 38.211 for each supported combination of a number of CSI-RS ports Nand a corresponding CDM type. In such a design, each CSI-RS resource set configuration includes exactly one CSI-RS resource configured with NCSI-RS ports, such that the resource index q is equal to zero and the total number of ports Nₜₒₜ is equal to N. Stated differently, every combination of port count and CDM type that the system intends to support is explicitly represented by a corresponding row in the extended configuration table. As a result, the UE or the network may configured CSI-RS resources directly from the table without relying on aggregation of multiple CSI-RS resources, thereby eliminating the need for resource aggregation mechanisms used in legacy NR systems. This approach enables native configuration of large-port CSI-RS resources and provides improved clarity, flexibility, and efficiency in CSI-RS resource signaling.

In one example, at least one additional row is included in Table 7.4.1.5.3-1 of TS 38.211 for at least one supported combination of a number of CSI-RS ports Nand a corresponding CDM type. In such a case, a CSI-RS resource having a number of ports Nand/or a CDM type that is not explicitly represented by a row in the extended table may instead be formed by aggregating KCSI-RS resources, each with NCSI-RS ports. This enables certain combinations of port counts and CDM types to be configured directly, while other combinations continue to rely on aggregation as in legacy approaches.

For example, the UE or the network may add at least one CSI-RS resource configuration to Table 7.4.1.5.3-1 that explicitly supports a number of ports N=64 with a CDM type of fd-CDM2. In this case, the UE or the network may configured a CSI-RS resource with N=64 ports and CDM type fd-CDM2 directly without any resource aggregation. Meanwhile, a CSI-RS resource with N=64 ports and a different CDM type, such as cdm8-FD2-TD4, may still be formed by aggregating K=4 CSI-RS resources of N=16 ports each or by aggregating K=2 CSI-RS resources of N=32 ports each, even though the CDM type of those aggregated smaller-port resources does not match the desired CDM type. In this manner, the system supports direct configuration for selected port-CDM combinations while preserving aggregation options for other combinations that need not be explicitly defined in the extended table.

In some examples, the supported combinations of Nₜₒₜ, K, and Nin Table 7.4.1.5.3-6 of TS 38.211—such as combinations for total CSI-RS port counts of 128—may also be extended to incorporate newly added rows of the CSI-RS configuration table. For instance, the UE or the network may include combinations associated with N=64 in the example above as part of the supported aggregation options, as illustrated in Table 1. Such extension allows total port counts such as 128, 256, or 512 to be achieved through aggregation that incorporates both legacy rows and newly added rows of the extended CSI-RS configuration table.

TABLE 1
The supported combinations of Nₜₒₜ, K, and N when the
number of CSI-RS ports is, e.g., 128, 256, or 512

| Nₜₒₜ | K | N |
|---|---|---|
| 128 | 2 | 64 |

In one example, the CSI-RS resource configuration table-such as Table 7.4.1.5.3-1 of TS 38.211—is extended to include one or more additional columns that enable implicit determination of resource-element (RE) locations for CDM groups across multiple resource blocks (RBs) and/or multiple slots. In one example, a first additional column may specify the number or indexes of RBs in which the REs of one or more CDM groups of a CSI-RS resource are implicitly determined relative to one or more CDM groups that are explicitly configured in a first RB. A second additional column may specify the number or indexes of slots in which the REs of one or more CDM groups are implicitly determined relative to CDM groups explicitly configured in a first slot. Through these extensions, the UE may derive RE positions for additional CDM groups based on offsets in either the frequency domain, the time domain, or both, without requiring explicit signaling of all CDM groups.

For example, Table 2 illustrates two CSI-RS resource configurations for a CSI-RS resource with 128 ports and a CDM type of cdm16-FD2-TD8, consisting of eight CDM groups indexed from j=0 to j=7. In Row 1 of Table 2, the eight CDM groups are time-division-multiplexed across two consecutive slots, with four CDM groups mapped to each slot. In Row 2, the eight CDM groups are frequency-division-multiplexed across two consecutive RBs, with four CDM groups mapped to each RB.

TABLE 2
128 Ports with cdm16-FD2-TD8

| | Ports | Density | | | CDM group | | |
|---|---|---|---|---|---|---|---|
| Row | N | ρ | cdm-Type | (k̅_{q}, l̅_{q}) | index j | \acute{k}_{q} | ĺ_{q} |
| 1 | 128 | 1, 0.5, | Cdm16- | (k₀, l₀), (k₁, l₀), (k₂, l₀), (k₃, l₀) | 0, 1, . . . , 7 | 0, 1 | 0, 1, 2, . . . , 7 |
| | | 0.25, . . . | FD2-TD8 | (k₀, l₀ + 14), (k₁, l₀ + 14), | | | |
| | | | | (k₂, l₀ + 14), (k₃, l₀ + 14) | | | |
| 2 | 128 | 1, 0.5, | Cdm16- | (k₀, l₀), (k₁, l₀), (k₂, l₀), (k₃, l₀) | 0, 1, . . . , 7 | 0, 1 | 0, 1, 2, . . . , 7 |
| | | 0.25, . . . | FD2-TD8 | (k₀ + 12, l₀), (k₁ + 12, l₀), | | | |
| | | | | (k₂ + 12, l₀), (k₃ + 12, l₀) | | | |

Table 3 provides an alternative configuration for the same CSI-RS resource, in which two new columns—denoted \tilde{k}_{g} and \tilde{l}_{q}—are added to the table. The column Kg specifies the number or indexes of RBs in which the REs of particular CDM groups are implicitly determined relative to CDM groups explicitly configured in a first RB. For instance, the UE or the network may implicitly derive a fifth CDM group relative to a first CDM group, a sixth CDM group implicitly derived relative to a second CDM group, and so on, for example by adding a fixed frequency-domain offset (such as 12 subcarriers) to the anchor RE locations of the corresponding base CDM groups. Similarly, the column \tilde{l}_{q} specifies the number or indexes of slots in which the REs of CDM groups are implicitly determined relative to CDM groups explicitly configured in a first slot, for example by adding a time-domain offset (such as 14 OFDM symbols) to the anchor RE locations of the corresponding explicitly signaled CDM groups.

TABLE 3
128 Ports with cdm16-FD2-TD8

| | Ports | Density | | | CDM group | | | | |
|---|---|---|---|---|---|---|---|---|---|
| Row | N | ρ | cdm-Type | (k̅_{q}, l̅_{q}) | index j | \acute{k}_{q} | ĺ_{q} | \tilde{k}_{q} | \tilde{l}_{q} |
| 1 | 128 | 1, 0.5, | Cdm16- | (k₀, l₀), (k₁, l₀), (k₂, l₀), | 0, 1, . . . , 7 | 0, 1 | 0, 1, 2, . . . , 7 | 0 | 0, 1 |
| | | 0.25, . . . | FD2-TD8 | (k₃, l₀) | | | | | |
| 2 | 128 | 1, 0.5, | Cdm16- | (k₀, l₀), (k₁, l₀), (k₂, l₀), | 0, 1, . . . , 7 | 0, 1 | 0, 1, 2, . . . , 7 | 0, 1 | 0 |
| | | 0.25, . . . | FD2-TD8 | (k₃, l₀) | | | | | |

In Row 1 of Table 3, the values \tilde{k}_{q}=0 and \tilde{l}_{q}={0,1} indicate that the associated CDM groups are mapped across two slots within a single RB, with the anchor REs of the first four CDM groups explicitly configured for the first slot and the anchor REs of the remaining CDM groups implicitly derived for the second slot. In another example, Row 2 of Table 3 provides \tilde{k}_{q}={0,1} and \tilde{l}_{q}=0, indicating that the associated CDM groups are mapped across two RBs within a single slot, with the anchor REs of the first four CDM groups explicitly configured for the first RB and the remaining CDM groups implicitly derived for the second RB. These table extensions enable flexible, scalable configuration of CSI-RS resources with large numbers of ports while reducing the need for explicitly signaling RE locations for all CDM groups.

In some examples, the UE or the network may configure a time-domain offset and/or a frequency-domain offset for a CSI-RS resource, either by including additional fields in the extended CSI-RS configuration table (for example, as separate columns specifying a frequency density or shift ρ_{f} and a time density or shift ρₜ) or by signaling such offsets through a CSI-RS configuration message, such as a CSI-RS resource-mapping configuration message. The offset parameter ρ_{f} may apply when the number of indexes specified under \tilde{k}_{q} is greater than one and may indicate that consecutive RBs associated with implicitly determined CDM groups are separated by ρ_{f} RBs. For instance, the UE or the network may separate the first and second RBs by ρ_{f} RBs, the second and third RBs by ρ_{f} RBs, and so forth. Similarly, the offset parameter ρₜ may apply when more than one index is specified under \tilde{l}_{q}, and may indicate that consecutive slots associated with implicitly determined CDM groups are separated by ρₜ slots.

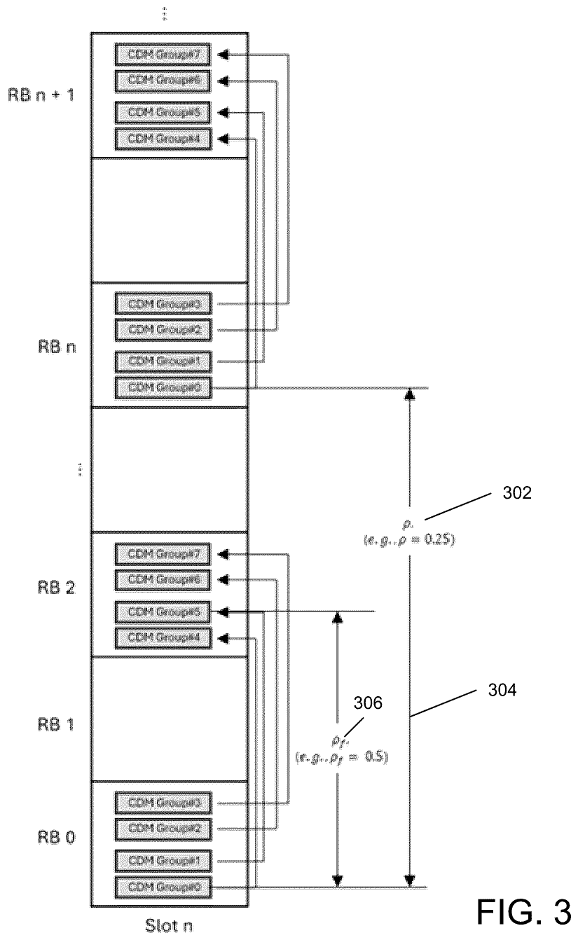

It is useful to distinguish the role of these offsets from the density parameter p specified in the third column of Table 7.4.1.5.3-1 in TS 38.211. The density ρ 302 determines the RB spacing 304 between repeated occurrences of the same CDM group within a CSI-RS resource. For example, a density of ρ=0.5 may imply that consecutive occasions of the same CDM group are separated by one RB. In contrast, the offset ρ_{f} 306 governs the RB separation between different CDM groups, such as between an explicitly configured CDM group and a CDM group that is implicitly determined based on that explicitly configured group. For example, with a value ρ_{f}=0.5, the UE or the network may separate the implicitly determined CDM group (for example, the fifth CDM group in the earlier example) from the explicitly configured CDM group (such as the first CDM group) by one RB, as illustrated in FIG. 3.

In some examples, the UE or the network may implicitly determine or derive one or both of the offset parameters ρ_{f} and ρₜ relative to the configured density ρ. This allows the UE to compute consistent time-domain and frequency-domain placements for implicitly determined CDM groups without requiring explicit signaling of all CDM-group positions, thereby enabling scalable CSI-RS configurations for large numbers of ports.

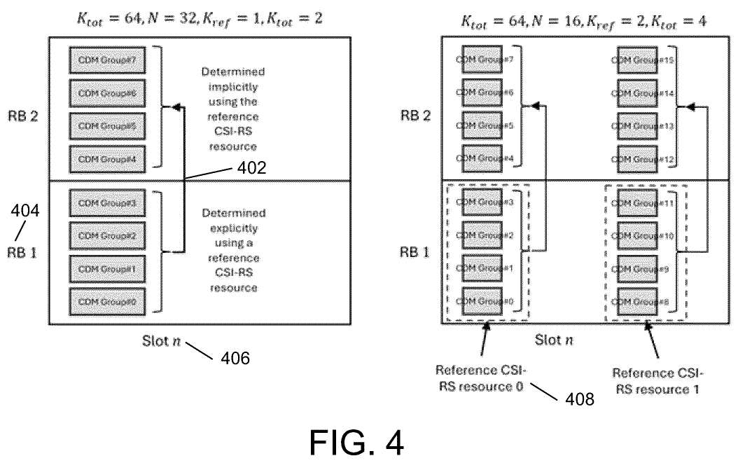

In one example, shown in FIG. 4, when a CSI-RS resource is associated with a number of ports greater than a threshold value Nₘᵢₙ (for example, Nₘᵢₙ=32) and the mapping occasions of the corresponding CDM groups 402 span multiple resource blocks (RBs) 404 and/or multiple slots 406, while the CSI-RS configuration table (such as Table 7.4.1.5.3-1 of TS 38.211) provides explicit RE locations only for CSI-RS resources with port counts less than or equal to Nₘᵢₙ, a CSI-RS resource-mapping configuration message may include a CSI-RS resource set configuration with K_{ref}≥1 reference CSI-RS resources 408. The configuration message may further include an indication of a mapping type and one or more offset or density parameters, such as a frequency density/offset/shift ρ_{f} and a time density/offset/shift ρₜ. The UE may use these parameters to determine RE locations for CDM groups or REs located outside the reference RB or reference slot. The mapping type may indicate frequency-domain mapping (FD-mapping), time-domain mapping (TD-mapping), or combined frequency-time mapping (FD-TD mapping), for example encoded as a codepoint. In other words, when a total number of ports Nₜₒₜ greater than Nₘᵢₙ is configured, the UE or the network may implicitly determine one or more of the Kₜₒₜ aggregated CSI-RS resources based on K_{ref}reference CSI-RS resources, each having N ports, together with the mapping type and the offset parameters ρ_{f} and/or ρₜ, such that Nₜₒₜ=KₜₒₜN.

For example, consider the current CSI-RS configuration table in Table 7.4.1.5.3-1 of TS 38.211. To configure a CSI-RS resource with Nₜₒₜ=64 ports, a UE may receive a single reference CSI-RS resource configuration with N=32 ports (for instance, corresponding to Row 18), a mapping type of FD-mapping, a frequency density ρ_{f}=1, and a time density ρₜ=0. In this case, the UE determines that Kₜₒₜ=Nₜₒₜ/N=2, and implicitly derives the RE locations for the second CSI-RS resource using the parameters of the reference 32-port resource together with the indicated mapping type and offset parameters.

In another example, again considering the configuration table in Table 7.4.1.5.3-1, the UE or the network may configure a CSI-RS resource with Nₜₒₜ=64 ports by providing the UE with two reference CSI-RS resources, each with N=16 ports (for instance, corresponding to Row 12). The UE may also receive a mapping type of FD-mapping, a frequency density ρ_{f}=1, and a time density ρₜ=0. In this scenario, the UE determines that Kₜₒₜ=Nₜₒₜ/N=4, and derives the RE locations of the third and fourth CSI-RS resources implicitly, based on the explicitly configured first two reference CSI-RS resources and the indicated mapping and offset parameters.

TABLE 4
48 Ports with fd-CDM2

| | Ports | Density | | | CDM group | | |
|---|---|---|---|---|---|---|---|
| Row | N | ρ | cdm-Type | (k̅, l̅) | index j | \acute{k} | ĺ |
| 1 | 48 | 1, 0.5, | fd-CDM2 | (k₀, l₀), (k₁, l₀), (k₂, l₀), (k₃, l₀), (k₄, l₀), (k₅, l₀) | 0, 1, 2, . . . , 23 | 0, 1 | 0 |
| | | 0.25, . . . | | (k₀, l₀ + 1), (k₁, l₀ + 1), (k₂, l₀ + 1), (k₃, l₀ + 1), | | | |
| | | | | (k₄, l₀ + 1), (k₅, l₀ + 1) | | | |
| | | | | (k₀, l₁), (k₁, l₁), (k₂, l₁), (k₃, l₁), (k₄, l₁), (k₅, l₁) | | | |
| | | | | (k₀, l₁ + 1), (k₁, l₁ + 1), (k₂, l₁ + 1), (k₃, l₁ + 1), | | | |
| | | | | (k₄, l₁ +1), (k₅, l₁ + 1) | | | |
| 2 | 48 | 1, 0.5, | fd-CDM2 | (k₀, l₀), (k₁, l₀), (k₂, l₀), (k₃, l₀), | 0, 1, 2, . . . , 23 | 0, 1 | 0 |
| | | 0.25, . . . | | (k₀, l₀ + 1), (k₁, l₀ + 1), (k₂, l₀ + 1), (k₃, l₀ + 1), | | | |
| | | | | (k₀, l₀ + 2), (k₁, l₀ + 2), (k₂, l₀ + 2), (k₃, l₀ + 2), | | | |
| | | | | (k₀, l₁), (k₁, l₀), (k₂, l₁), (k₃, l₁), | | | |
| | | | | (k₀, l₁ + 1), (k₁, l₁ + 1), (k₂, l₁ + 1), (k₃, l₁ + 1), | | | |
| | | | | (k₀, l₁ + 2), (k₁, l₁ + 2), (k₂, l₁ + 2), (k₃, l₁ + 2) | | | |
| 3 | 48 | 1, 0.5, | fd-CDM2 | (k₀, l₀), (k₁, l₀), (k₂, l₀), (k₃, l₀), | 0, 1, 2, . . . , 23 | 0, 1 | 0 |
| | | 0.25, . . . | | (k₀, l₀ + 1), (k₁, l₀ + 1), (k₂, l₀ + 1), (k₃, l₀ + 1), | | | |
| | | | | (k₀, l₁), (k₁, l₁), (k₂, l₁), (k₃, l₁), | | | |
| | | | | (k₀, l₁ + 1), (k₁, l₁ + 1), (k₂, l₁ + 1), (k₃, l₁ + 1), | | | |
| | | | | (k₀, l₃), (k₁, l₃), (k₂, l₃), (k₃, l₃), | | | |
| | | | | (k₀, l₃ + 1), (k₁, l₃ + 1), (k₂, l₃ + 1), (k₃, l₃ + 1), | | | |

TABLE 5
48 Ports with cdm4-FD2-TD2

| | Ports | Density | | | CDM group | | |
|---|---|---|---|---|---|---|---|
| Row | N | ρ | cdm-Type | (k̅_{q}, l̅_{q}) | index j | \acute{k}_{q} | ĺ_{q} |
| 1 | 48 | 1, 0.5, | Cdm4- | (k₀, l₀), (k₁, l₀), (k₂, l₀), | 0, 1, 2, . . . , 11 | 0, 1 | 0, 1 |
| | | 0.25, . . . | FD2-TD2 | (k₀, l₁), (k₁, l₁), (k₂, l₁) | | | |
| | | | | (k₀, l₂), (k₁, l₂), (k₂, l₂) | | | |
| | | | | (k₀, l₃), (k₁, l₃), (k₂, l₃) | | | |
| 2 | 48 | 1, 0.5, | Cdm4- | (k₀, l₀), (k₁, l₀), (k₂, l₀), (k₃, l₀) | 0, 1, 2, . . . , 11 | 0, 1 | 0, 1 |
| | | 0.25, . . . | FD2-TD2 | (k₀, l₁), (k₁, l₁), (k₂, l₁), (k₃, l₁) | | | |
| | | | | (k₀, l₂), (k₁, l₂), (k₂, l₂), (k₃, l₂) | | | |
| 3 | 48 | 1, 0.5, | Cdm4- | (k₀, l₀), (k₁, l₀), (k₂, l₀), (k₃, l₀), (k₄, l₀), (k₅, l₀) | 0, 1, 2, . . . , 11 | 0, 1 | 0, 1 |
| | | 0.25, . . . | FD2-TD2 | (k₀, l₁), (k₁, l₁), (k₂, l₁), (k₃, l₁), (k₄, l₁), (k₅, l₁) | | | |

TABLE 6
48 Ports with cdm8-FD2-TD4

| | Ports | Density | | | CDM group | | |
|---|---|---|---|---|---|---|---|
| Row | N | ρ | cdm-Type | (k̅_{q}, l̅_{q}) | index j | \acute{k}_{q} | ĺ_{q} |
| 1 | 48 | 1, 0.5, | Cdm8- | (k₀, l₀), (k₁, l₀), (k₂, l₀), (k₃, l₀), (k₄, l₀), (k₅, l₀) | 0, 1, 2, . . . , 5 | 0, 1 | 0, 1, 2, 3 |
| | | 0.25, . . . | TFD2-D4 | | | | |
| 2 | 48 | 1, 0.5, | Cdm8- | (k₀, l₀), (k₁, l₀), (k₂, l₀) | 0, 1, 2, . . . , 5 | 0, 1 | 0, 1, 2, 3 |
| | | 0.25, . . . | FD2-TD4 | (k₃, l₁), (k₄, l₁), (k₅, l₁) | | | |

TABLE 7
48 Ports with cdm16-FD2-TD8

| | Ports | Density | | | CDM group | | |
|---|---|---|---|---|---|---|---|
| Row | N | ρ | cdm-Type | (k̅_{q}, l̅_{q}) | index j | \acute{k}_{q} | ĺ_{q} |
| 1 | 48 | 1, 0.5, | Cdm16- | (k₀, l₀), (k₁, l₀), (k₂, l₀) | 0, 1, 2 | 0, 1 | 0, 1, 2, . . . , 7 |
| | | 0.25, . . . | FD2-TD8 | | | | |

TABLE 8
48 Ports with cdm16-FD4-TD4

| | Ports | Density | | | CDM group | | |
|---|---|---|---|---|---|---|---|
| Row | N | ρ | cdm-Type | (k̅_{q}, l̅_{q}) | index j | \acute{k}_{q} | ĺ_{q} |
| 1 | 48 | 1, 0.5, | Cdm16- | (k₀, l₀), (k₁, l₀), (k₂, l₀) | 0, 1, 2 | 0, 1, 2, 3 | 0, 1, 2, 3 |
| | | 0.25, . . . | FD4-TD4 | | | | |

TABLE 9
64 Ports with fd-CDM2

| | Ports | Density | | | CDM group | | |
|---|---|---|---|---|---|---|---|
| Row | N | ρ | cdm-Type | (k̅_{q}, l̅_{q}) | index j | \acute{k}_{q} | ĺ_{q} |
| 1 | 64 | 1, 0.5, | fd-CDM2 | (k₀, l₀), (k₁, l₀), (k₂, l₀), (k₃, l₀), | 0, 1, 2, . . . , 31 | 0, 1 | 0 |
| | | 0.25, . . . | | (k₀, l₀ + 1), (k₁, l₀ + 1), (k₂, l₀ + 1), (k₃, l₀ + 1), | | | |
| | | | | (k₀, l₁), (k₁, l₁), (k₂, l₁), (k₃, l₁) | | | |
| | | | | (k₀, l₁ + 1), (k₁, l₁ + 1), (k₂, l₁ + 1), (k₃, l₁ + 1) | | | |
| | | | | (k₀, l₂), (k₁, l₂), (k₂, l₂), (k₃, l₂) | | | |
| | | | | (k₀, l₂ + 1), (k₁, l₂ + 1), (k₂, l₂ + 1), (k₃, l₂ + 1) | | | |
| | | | | (k₀, l₃), (k₁, l₃), (k₂, l₃), (k₃, l₃) | | | |
| | | | | (k₀, l₃ + 1), (k₁, l₃ + 1), (k₂, l₃ + 1), (k₃, l₃ + 1) | | | |
| 2 | 64 | 1, 0.5, | fd-CDM2 | (k₀, l₀), (k₁, l₀), (k₂, l₀), (k₃, l₀), | 0, 1, 2, . . . , 31 | 0, 1 | 0 |
| | | 0.25, . . . | | (k₀, l₀ + 1), (k₁, l₀ + 1), (k₂, l₀ + 1), (k₃, l₀ + 1), | | | |
| | | | | (k₀, l₀ + 2), (k₁, l₀ + 2), (k₂, l₀ + 2), (k₃, l₀ + 2) | | | |
| | | | | (k₀, l₀ + 3), (k₁, l₀ + 3), (k₂, l₀ + 3), (k₃, l₀ + 3), | | | |
| | | | | (k₀, l₂), (k₁, l₂), (k₂, l₂), (k₃, l₂) | | | |
| | | | | (k₀, l₂ + 1), (k₁, l₂ + 1), (k₂, l₂ + 1), (k₃, l₂ + 1) | | | |
| | | | | (k₀, l₂ + 2), (k₁, l₂ + 2), (k₂, l₂ + 2), (k₃, l₂ + 2) | | | |
| | | | | (k₀, l₃ + 3), (k₁, l₃ + 3), (k₂, l₃ + 3), (k₃, l₃ + 3) | | | |

TABLE 10
64 Ports with cdm4-FD2-TD2

| | Ports | Density | | | CDM group | | |
|---|---|---|---|---|---|---|---|
| Row | N | ρ | cdm-Type | (k̅_{q}, l̅_{q}) | index j | \acute{k}_{q} | ĺ_{q} |
| 1 | 64 | 1, 0.5, | cdm4- | (k₀, l₀), (k₁, l₀), (k₂, l₀), (k₃, l₀), | 0, 1, 2, . . . , 15 | 0, 1 | 0, 1 |
| | | 0.25, . . . | FD2-TD2 | (k₀, l₁), (k₁, l₁), (k₂, l₁), (k₃, l₁) | | | |
| | | | | (k₀, l₂), (k₁, l₂), (k₂, l₂), (k₃, l₂) | | | |
| | | | | (k₀, l₃), (k₁, l₃), (k₂, l₃), (k₃, l₃) | | | |
| 2 | 64 | 1, 0.5, | cdm4- | (k₀, l₀), (k₁, l₀), (k₂, l₀), (k₃, l₀), | 0, 1, 2, . . . , 15 | 0, 1 | 0, 1 |
| | | 0.25, . . . | FD2-TD2 | (k₀ + 12, l₀), (k₁12, l₀), (k₂12, l₀), (k₃ + 12, l₀) | | | |
| | | | | (k₀, l₁), (k₁, l₁), (k₂, l₁), (k₃, l₁) | | | |
| | | | | (k₀, l₁ + 12), (k₁, l₁ + 12), (k₂, l₁ + 12), | | | |
| | | | | (k₃, l₁ + 12) | | | |

TABLE 11
64 Ports with cdm8-FD2-TD4

| | Ports | Density | | | CDM group | | |
|---|---|---|---|---|---|---|---|
| Row | N | ρ | cdm-Type | (k̅_{q}, l̅_{q}) | index j | \acute{k}_{q} | ĺ_{q} |
| 1 | 64 | 1, 0.5, | cdm8- | (k₀, l₀), (k₁, l₀), (k₂, l₀), (k₃, l₀), | 0, 1, 2, . . . , 7 | 0, 1 | 0, 1, 2, 3 |
| | | 0.25, . . . | FD2-TD4 | (k₀, l₁), (k₁, l₁), (k₂, l₁), (k₃, l₁) | | | |
| 2 | 64 | 1, 0.5, | cdm8- | (k₀, l₀), (k₁, l₀), (k₂, l₀), (k₃, l₀), | 0, 1, 2, . . . , 7 | 0, 1 | 0, 1, 2, 3 |
| | | 0.25, . . . | FD2-TD4 | (k₀ + 12, l₀), (k₁ + 12, l₀), (k₂ + 12, l₀), | | | |
| | | | | (k₃ + 12, l₀), | | | |

TABLE 12
64 Ports with cdm16-FD2-TD8

| | Ports | Density | | | CDM group | | |
|---|---|---|---|---|---|---|---|
| Row | N | ρ | cdm-Type | (k̅_{q}, l̅_{q}) | index j | \acute{k}_{q} | ĺ_{q} |
| 1 | 64 | 1, 0.5, | cdm16- | (k₀, l₀), (k₁, l₀), (k₂, l₀), (k₃, l₀) | 0, 1, 2, 3 | 0, 1 | 0, 1, 2, . . . , 7 |
| | | 0.25, . . . | FD2-TD8 | | | | |
| 2 | 64 | 1, 0.5, | cdm16- | (k₀, l₀), (k₁, l₀), | 0, 1, 2, 3 | 0, 1 | 0, 1, 2, . . . , 7 |
| | | 0.25, . . . | FD2-TD8 | (k₀ + 12, l₀), (k₁ + 12, l₀) | | | |

TABLE 13
64 Ports with cdm 16-FD4-TD4

| | Ports | Density | | | CDM group | | |
|---|---|---|---|---|---|---|---|
| Row | N | ρ | cdm-Type | (k̅_{q}, l̅_{q}) | index j | \acute{k}_{q} | ĺ_{q} |
| 1 | 64 | 1, 0.5, | cdm16- | (k₀, l₀), (k₁, l₀), | 0, 1, 2, 3 | 0, 1, 2, 3 | 0, 1, 2, 3 |
| | | 0.25, . . . | FD4-TD4 | (k₀, l₁), (k₁, l₁) | | | |
| 2 | 64 | 1, 0.5, | cdm16- | (k₀, l₀), (k₁, l₀), | 0, 1, 2, 3 | 0, 1, 2, 3 | 0, 1, 2, 3 |
| | | 0.25, . . . | FD4-TD4 | (k₀ + 12, l₀), (k₁ + 12, l₀), | | | |

TABLE 14
64 Ports with cdm32-FD4-TD8

| | Ports | Density | | | CDM group | | |
|---|---|---|---|---|---|---|---|
| Row | N | ρ | cdm-Type | (k̅_{q}, l̅_{q}) | index j | \acute{k}_{q} | ĺ_{q} |
| 1 | 64 | 1, 0.5, | Cdm32- | (k₀, l₀), (k₁, l₀) | 0, 1 | 0, 1, 2, 3 | 0, 1, 2, . . . , 7 |
| | | 0.25, . . . | FD4-TD8 | | | | |
| 2 | 64 | 1, 0.5, | Cdm32- | (k₀, l₀), (k₀ + 12, l₀) | 0, 1 | 0, 1, 2, 3 | 0, 1, 2, . . . , 7 |
| | | 0.25, . . . | FD4-TD8 | | | | |

TABLE 15
128 Ports with cdm4-FD2-TD2

| | | | | | CDM | | |
|---|---|---|---|---|---|---|---|
| | Ports | Density | cdm- | | group | | |
| Row | N | ρ | Type | (k̅_{q}, l̅_{q}) | index j | \acute{k}_{q} | ĺ_{q} |
| 1 | 128 | 1, 0.5, | cdm4- | (k₀, l₀), (k₁, l₀), (k₂, l₀), (k₃, l₀), | 0, 1, . . . , 31 | 0, 1 | 0, 1 |
| | | 0.25, . . . | FD2- | (k₀, l₁), (k₁, l₁), (k₂, l₁), (k₃, l₁), | | | |
| | | | TD2 | (k₀, l₂), (k₁, l₂), (k₂, l₂), (k₃, l₂), | | | |
| | | | | (k₀, l₃), (k₁, l₃), (k₂, l₃), (k₃, l₃), | | | |
| | | | | (k₀, l₀ + 14), (k₁, l₀ + 14), (k₂, l₀ + | | | |
| | | | | 14), (k₃, l₀ + 14), | | | |
| | | | | (k₀, l₁ + 14), (k₁, l₁ + 14), (k₂, l₁ + 14), | | | |
| | | | | (k₃, l₁ + 14), | | | |
| | | | | (k₀, l₂ + 14), (k₁, l₂ + 14), (k₂, l₂ + | | | |
| | | | | 14), (k₃, l₂ + 14), | | | |
| | | | | (k₀, l₃ + 14), (k₁, l₃ + 14), (k₂, l₃ + | | | |
| | | | | 14), (k₃, l₃ + 14) | | | |
| 2 | 128 | 1, 0.5, | cdm4- | (k₀, l₀), (k₁, l₀), (k₂, l₀), (k₃, l₀), | 0, 1, . . . , 31 | 0, 1 | 0, 1 |
| | | 0.25, . . . | FD2- | (k₀ + 12, l₀), (k₁ + 12, l₀), (k₂ + | | | |
| | | | TD2 | 12, l₀), (k₃ + 12, l₀), | | | |
| | | | | (k₀, l₁), (k₁, l₁), (k₂, l₁), (k₃, l₁), | | | |
| | | | | (k₀ + 12, l₁), (k₁ + 12, l₁), (k₂ + 12, l₁), | | | |
| | | | | (k₃ + 12, l₁), | | | |
| | | | | (k₀, l₂), (k₁, l₂), (k₂, l₂), (k₃, l₂), | | | |
| | | | | (k₀ + 12, l₂), (k₁ + 12, l₂), (k₂ + | | | |
| | | | | 12, l₂), (k₃ + 12, l₂), | | | |
| | | | | (k₀, l₃), (k₁, l₃), (k₂, l₃), (k₃, l₃), | | | |
| | | | | (k₀ + 12, l₃), (k₁ + 12, l₃), (k₂ + | | | |
| | | | | 12, l₃), (k₃ + 12, l₃), | | | |
| 3 | 128 | 1, 0.5, | cdm4- | (k₀, l₀), (k₁, l₀), (k₂, l₀), (k₃, l₀), | 0, 1, . . . , 31 | 0, 1 | 0, 1 |
| | | 0.25, . . . | FD2- | (k₀ + 12, l₀), (k₁ + 12, l₀), (k₂ + | | | |
| | | | TD2 | 12, l₀), (k₃ + 12, l₀), | | | |
| | | | | (k₀ + 24, l₀), (k₁ + 24, l₀), (k₂ + | | | |
| | | | | 24, l₀), (k₃ + 24, l₀), | | | |
| | | | | (k₀ + 36, l₀), (k₁ + 36, l₀), (k₂ + | | | |
| | | | | 36, l₀), (k₃ + 36, l₀), | | | |
| | | | | (k₀, l₁), (k₁, l₁), (k₂, l₁), (k₃, l₁), | | | |
| | | | | (k₀ + 12, l₁), (k₁ + 12, l₁), (k₂ + 12, l₁), | | | |
| | | | | (k₃ + 12, l₁), | | | |
| | | | | (k₀ + 24, l₁), (k₁ + 24, l₁), (k₂ + 24, l₁), | | | |
| | | | | (k₃ + 24, l₁), | | | |
| | | | | (k₀ + 36, l₁), (k₁ + 36, l₁), (k₂ + 36, l₁), | | | |
| | | | | (k₃ + 36, l₁), | | | |

TABLE 16
128 Ports with cdm8-FD2-TD4

| | | | | | CDM | | |
|---|---|---|---|---|---|---|---|
| | Ports | Density | cdm- | | group | | |
| Row | N | ρ | Type | (k̅_{q}, l̅_{q}) | index j | \acute{k}_{q} | ĺ_{q} |
| 1 | 128 | 1, 0.5, | cdm8- | (k₀, l₀), (k₁, l₀), (k₂, l₀), (k₃, l₀) | 0, 1, . . . 15 | 0, 1 | 0, 1, 2, 3 |
| | | 0.25, . . . | FD2- | (k₀, l₁), (k₁, l₁), (k₂, l₁), (k₃, l₁) | | | |
| | | | TD4 | (k₀, l₀ + 14), (k₁, l₀ + 14), (k₂, l₀ + | | | |
| | | | | 14), (k₃, l₀ + 14) | | | |
| | | | | (k₀, l₁ + 14), (k₁, l₁ + 14), (k₂, l₁ + | | | |
| | | | | 14), (k₃, l₁ + 14) | | | |
| 2 | 128 | 1, 0.5, | cdm8- | (k₀, l₀), (k₁, l₀), (k₂, l₀), (k₃, l₀) | 0, 1, . . . 15 | 0, 1 | 0, 1, 2, 3 |
| | | 0.25, . . . | FD2- | (k₀ + 12, l₀), (k₁ + 12, l₀), (k₂ + | | | |
| | | | TD4 | 12, l₀), (k₃ + 12, l₀) | | | |
| | | | | (k₀, l₁), (k₁, l₁), (k₂, l₁), (k₃, l₁) | | | |
| | | | | (k₀ + 12, l₁), (k₁ + 12, l₁), (k₂ + | | | |
| | | | | 12, l₁), (k₃ + 12, l₁) | | | |
| 3 | 128 | 1, 0.5, | cdm8- | (k₀, l₀), (k₁, l₀), (k₂, l₀), (k₃, l₀) | 0, 1, . . . 15 | 0, 1 | 0, 1, 2, 3 |
| | | 0.25, . . . | FD2- | (k₀ + 12, l₀), (k₁ + 12, l₀), (k₂ + | | | |
| | | | TD4 | 12, l₀), (k₃ + 12, l₀) | | | |
| | | | | (k₀ + 24, l₀), (k₁ + 24, l₀), (k₂ + | | | |
| | | | | 24, l₀), (k₃ + 24, l₀) | | | |
| | | | | (k₀ + 36, l₀), (k₁ + 36, l₀), (k₂ + | | | |
| | | | | 36, l₀), (k₃ + 36, l₀) | | | |

TABLE 17
128 Ports with cdm16-FD2-TD8

| | | | | | CDM | | |
|---|---|---|---|---|---|---|---|
| | Ports | Density | cdm- | | group | | |
| Row | N | ρ | Type | (k̅_{q}, l̅_{q}) | index j | \acute{k}_{q} | ĺ_{q} |
| 1 | 128 | 1, 0.5, | Cdm16- | (k₀, l₀), (k₁, l₀), (k₂, l₀), (k₃, l₀) | 0, 1, . . . , 7 | 0, 1 | 0, 1, 2, . . . , 7 |
| | | 0.25, . . . | FD2- | (k₀, l₀ + 14), (k₁, l₀ + 14), (k₂, l₀ + | | | |
| | | | TD8 | 14), (k₃, l₀ + 14) | | | |
| 2 | 128 | 1, 0.5, | Cdm16- | (k₀, l₀), (k₁, l₀), (k₂, l₀), (k₃, l₀) | 0, 1, . . . , 7 | 0, 1 | 0, 1, 2, . . . , 7 |
| | | 0.25, . . . | FD2- | (k₀ + 12, l₀), (k₁ + 12, l₀), (k₂ + | | | |
| | | | TD8 | 12, l₀), (k₃ + 12, l₀) | | | |

TABLE 18
128 Ports with cdm16-FD4-TD4

| | | | | | CDM | | |
|---|---|---|---|---|---|---|---|
| | Ports | Density | cdm- | | group | | |
| Row | N | ρ | Type | (k̅_{q}, l̅_{q}) | index j | \acute{k}_{q} | ĺ_{q} |
| 1 | 128 | 1, 0.5, | Cdm16- | (k₀, l₀), (k₁, l₀) | 0, 1, . . . , 7 | 0, 1, 2, 3 | 0, 1, 2, 3 |
| | | 0.25, . . . | FD4- | (k₀, l₁), (k₁, l₁) | | | |
| | | | TD4 | (k₀, l₀ + 14), (k₁, l₀ + 14) | | | |
| | | | | (k₀, l₁ + 14), (k₁, l₁ + 14) | | | |
| 2 | 128 | 1, 0.5, | Cdm16- | (k₀, l₀), (k₁, l₀), | 0, 1, . . . , 7 | 0, 1, 2, 3 | 0, 1, 2, 3 |
| | | 0.25, . . . | FD4- | (k₀ + 12, l₀), (k₁ + 12, l₀), | | | |
| | | | TD4 | (k₀, l₁), (k₁, l₁) | | | |
| | | | | (k₀ + 12, l₁), (k₁ + 12, l₁) | | | |
| 3 | 128 | 1, 0.5, | Cdm16- | (k₀, l₀), (k₁, l₀), | 0, 1, . . . , 7 | 0, 1, 2, 3 | 0, 1, 2, 3 |
| | | 0.25, . . . | FD4- | (k₀ + 12, l₀), (k₁ + 12, l₀), | | | |
| | | | TD4 | (k₀ + 24, l₀), (k₁ + 24, l₀), | | | |

(k₀ + 36, l₀), (k₁ + 36, l₀)

TABLE 19
128 Ports with cdm32-FD4-TD8

| | | | | | CDM | | |
|---|---|---|---|---|---|---|---|
| | Ports | Density | cdm- | | group | | |
| Row | N | ρ | Type | (k̅_{q}, l̅_{q}) | index j | \acute{k}_{q} | ĺ_{q} |
| 1 | 128 | 1, 0.5, | Cdm32- | (k₀, l₀), (k₁, l₀), | 0, 1, 2, 3 | 0, 1, 2, 3 | 0, 1, 2, . . . , 7 |
| | | 0.25, . . . | FD4- | (k₀, l₀ + 14), (k₀, l₀ + 14), | | | |
| | | | TD8 | | | | |
| 2 | 128 | 1, 0.5, | Cdm32- | (k₀, l₀), (k₁, l₀), | 0, 1, 2, 3 | 0, 1, 2, 3 | 0, 1, 2, . . . , 7 |
| | | 0.25, . . . | FD4- | (k₀ + 12, l₀), (k₀ + 12, l₀), | | | |
| | | | TD8 | | | | |

TABLE 20
128 Ports with cdm64-FD8-TD8

| | | | | | CDM | | |
|---|---|---|---|---|---|---|---|
| | Ports | Density | cdm- | | group | | |
| Row | N | ρ | Type | (k̅_{q}, l̅_{q}) | index j | \acute{k}_{q} | ĺ_{q} |
| 1 | 128 | 1, 0.5, | Cdm64- | (k₀, l₀), (k₀, l₀ + 14), | 0, 1 | 0, 1, 2, . . . , 8 | 0, 1, 2, . . . , 7 |
| | | 0.25, . . . | FD8- | | | | |
| | | | TD8 | | | | |
| 2 | 128 | 1, 0.5, | Cdm64- | (k₀, l₀), (k₀ + 12, l₀), | 0, 1 | 0, 1, 2, . . . , 8 | 0, 1, 2, . . . , 7 |
| | | 0.25, . . . | FD8- | | | | |
| | | | TD8 | | | | |

TABLE 21
128 Ports with cdm8-FD2-TD4

| | | | | | CDM | | |
|---|---|---|---|---|---|---|---|
| | Ports | Density | cdm- | | group | | |
| Row | N | ρ | Type | (k̅_{q}, l̅_{q}) | index j | \acute{k}_{q} | ĺ_{q} |
| 1 | 256 | 1, 0.5, | Cdm8- | (k₀, l₀), (k₁, l₀), (k₂, l₀), (k₃, l₀) | 0, 1, . . . , | 0, 1 | 0, 1, 2, 3 |
| | | 0.25, . . . | FD2- | (k₀ + 12, l₀), (k₁ + 12, l₀), (k₂ + | 31 | | |
| | | | TD4 | 12, l₀), (k₃ + 12, l₀) | | | |
| | | | | (k₀, l₁), (k₁, l₁), (k₂, l₁), (k₃, l₁) | | | |
| | | | | (k₀ + 12, l₁), (k₁ + 12, l₁), (k₂ + | | | |
| | | | | 12, l₁), (k₃ + 12, l₁) | | | |
| | | | | (k₀, l₀ + 14), (k₁, l₀ + 14), (k₂, l₀ + | | | |
| | | | | 14), (k₃, l₀ + 14) | | | |
| | | | | (k₀ + 12, l₀ + 14), (k₁ + 12, l₀ + | | | |
| | | | | 14), (k₂ + 12, l₀ + 14), (k₃ + 12, l₀ + 14) | | | |
| | | | | (k₀, l₁ + 14), (k₁, l₁ + 14), (k₂, l₁ + | | | |
| | | | | 14), (k₃, l₁ + 14) | | | |
| | | | | (k₀ + 12, l₁ + 14), (k₁ + 12, l₁ + | | | |
| | | | | 14), (k₂ + 12, l₁ + 14), (k₃ + 12, l₁ + 14) | | | |
| 2 | 256 | 1, 0.5, | Cdm8- | (k₀, l₀), (k₁, l₀), (k₂, l₀), (k₃, l₀) | 0, 1, . . . , | 0, 1 | 0, 1, 2, 3 |
| | | 0.25, . . . | FD2- | (k₀ + 12, l₀), (k₁ + 12, l₀), (k₂ + | 31 | | |
| | | | TD4 | 12, l₀), (k₃ + 12, l₀) | | | |
| | | | | (k₀ + 24, l₀), (k₁ + 24, l₀), (k₂ + | | | |
| | | | | 24, l₀), (k₃ + 24, l₀) | | | |
| | | | | (k₀ + 36, l₀), (k₁ + 36, l₀), (k₂ + | | | |
| | | | | 36, l₀), (k₃ + 36, l₀) | | | |
| | | | | (k₀, l₁), (k₁, l₁), (k₂, l₁), (k₃, l₁) | | | |
| | | | | (k₀ + 12, l₁), (k₁ + 12, l₁), (k₂ + | | | |
| | | | | 12, l₁), (k₃ + 12, l₁) | | | |
| | | | | (k₀ + 24, l₁), (k₁ + 24, l₁), (k₂ + | | | |
| | | | | 24, l₁), (k₃ + 24, l₁) | | | |
| | | | | (k₀ + 36, l₁), (k₁ + 36, l₁), (k₂ + | | | |
| | | | | 36, l₁), (k₃ + 36, l₁) | | | |

TABLE 22
128 Ports with cdm16-FD2-TD8

| | | | | | CDM | | |
|---|---|---|---|---|---|---|---|
| | Ports | Density | cdm- | | group | | |
| Row | N | ρ | Type | (k̅_{q}, l̅_{q}) | index j | \acute{k}_{q} | ĺ_{q} |
| 1 | 256 | 1, 0.5, | Cdm16- | (k₀, l₀), (k₁, l₀), (k₂, l₀), (k₃, l₀) | 0, 1, . . . , | 0, 1 | 0, 1, 2, . . . , 7 |
| | | 0.25, . . . | FD2- | (k₀ + 12, l₀), (k₁ + 12, l₀), (k₂ + | 15 | | |
| | | | TD8 | 12, l₀), (k₃ + 12, l₀) | | | |
| | | | | (k₀, l₀ + 14), (k₁, l₀ + 14), (k₂, l₀ + | | | |
| | | | | 14), (k₃, l₀ + 14) | | | |
| | | | | (k₀ + 12, l₀ + 14), (k₁ + 12, l₀ + | | | |
| | | | | 14), (k₂ + 12, l₀ + 14), (k₃ + 12, l₀ + 14) | | | |
| 2 | 256 | 1, 0.5, | Cdm16- | (k₀, l₀), (k₁, l₀), (k₂, l₀), (k₃, l₀) | 0, 1, . . . , | 0, 1 | 0, 1, 2, . . . , 7 |
| | | 0.25, . . . | FD2- | (k₀ + 12, l₀), (k₁ + 12, l₀), (k₂ + | 15 | | |
| | | | TD8 | 12, l₀), (k₃ + 12, l₀) | | | |
| | | | | (k₀ + 24, l₀), (k₁ + 24, l₀), (k₂ + | | | |
| | | | | 24, l₀), (k₃ + 24, l₀) | | | |
| | | | | (k₀ + 36, l₀), (k₁ + 36, l₀), (k₂ + | | | |
| | | | | 36, l₀), (k₃ + 36, l₀) | | | |

TABLE 23
128 Ports with cdm16-FD4-TD4

| | | | | | CDM | | |
|---|---|---|---|---|---|---|---|
| | Ports | Density | cdm- | | group | | |
| Row | N | ρ | Type | (k̅_{q}, l̅_{q}) | index j | \acute{k}_{q} | ĺ_{q} |
| 1 | 256 | 1, 0.5, | Cdm16- | (k₀, l₀), (k₁, l₀) | 0, 1, . . . , | 0, 1, 2, 3 | 0, 1, 2, 3 |
| | | 0.25, . . . | FD4- | (k₀ + 12, l₀), (k₁ + 12, l₀) | 15 | | |
| | | | TD4 | (k₀, l₁), (k₁, l₁) | | | |
| | | | | (k₀ + 12, l₁), (k₁ + 12, l₁) | | | |
| | | | | (k₀, l₀ + 14), (k₁, l₀ + 14) | | | |
| | | | | (k₀ + 12, l₀ + 14), (k₁ + 12, l₀ + 14) | | | |
| | | | | (k₀, l₁ + 14), (k₁, l₁ + 14) | | | |
| | | | | (k₀ + 12, l₁ + 14), (k₁ + 12, l₁ + 14) | | | |
| 2 | 256 | 1, 0.5, | Cdm16- | (k₀, l₀), (k₁, l₀) | 0, 1, . . . , | 0, 1, 2, 3 | 0, 1, 2, 3 |
| | | 0.25, . . . | FD4- | (k₀ + 12, l₀), (k₁ + 12, l₀) | 15 | | |
| | | | TD4 | (k₀ + 24, l₀), (k₁ + 24, l₀) | | | |
| | | | | (k₀ + 36, l₀), (k₁ + 36, l₀) | | | |
| | | | | (k₀, l₁), (k₁, l₁) | | | |
| | | | | (k₀ + 12, l₁), (k₁ + 12, l₁) | | | |
| | | | | (k₀ + 24, l₁), (k₁ + 24, l₁) | | | |
| | | | | (k₀ + 36, l₁), (k₁ + 36, l₁) | | | |

TABLE 24
128 Ports with cdm32-FD4-TD8

| | | | | | CDM | | |
|---|---|---|---|---|---|---|---|
| | Ports | Density | cdm- | | group | | |
| Row | N | ρ | Type | (k̅_{q}, l̅_{q}) | index j | \acute{k}_{q} | ĺ_{q} |
| 1 | 256 | 1, 0.5, | Cdm32- | (k₀, l₀), (k₁, l₀), | 0, 1, . . . , 7 | 0, 1, 2, 3 | 0, 1, 2, . . . , 7 |
| | | 0.25, . . . | FD4- | (k₀ + 12, l₀), (k₁ + 12, l₀), | | | |
| | | | TD8 | (k₀, l₀ + 14), (k₁, l₀ + 14), | | | |
| | | | | (k₀ + 12, l₀ + 14), (k₁ + 12, l₀ + 14) | | | |
| 2 | 256 | 1, 0.5, | Cdm32- | (k₀, l₀), (k₁, l₀), | 0, 1, . . . , 7 | 0, 1, 2, 3 | 0, 1, 2, . . . , 7 |
| | | 0.25, . . . | FD4- | (k₀ + 12, l₀), (k₁ + 12, l₀), | | | |
| | | | TD8 | (k₀ + 24, l₀), (k₁ + 24, l₀), | | | |
| | | | | (k₀ + 36, l₀), (k₁ + 36, l₀) | | | |

TABLE 25
128 Ports with cdm64-FD8-TD8

| | | | | | CDM | | |
|---|---|---|---|---|---|---|---|
| | Ports | Density | cdm- | | group | | |
| Row | N | ρ | Type | (k̅_{q}, l̅_{q}) | index j | \acute{k}_{q} | ĺ_{q} |
| 1 | 256 | 1, 0.5, | Cdm64- | (k₀, l₀), (k₀ + 12, l₀) | 0, 1, 2, 3 | 0, 1, 2, . . . , 8 | 0, 1, 2, . . . , 7 |
| | | 0.25, . . . | FD8- | (k₀, l₀ + 14), (k₀ + 12, l₀ + 14), | | | |
| | | | TD8 | | | | |
| 2 | 256 | 1, 0.5, | Cdm64- | (k₀, l₀), (k₀ + 12, l₀) | 0, 1, 2, 3 | 0, 1, 2, . . . , 8 | 0, 1, 2, . . . , 7 |
| | | 0.25, . . . | FD8- | (k₀ + 24, l₀), (k₀ + 36, l₀), | | | |
| | | | TD8 | | | | |

TABLE 26
The sequences w_{f}(k_{q}′) and wₜ(l_{q}′) for
cdm-Type equal to ‘cdm16-FD2-TD8’

| Index | [w_{f}(0) w_{f}(1)] | [wₜ(0) wₜ(1) wₜ(2) wₜ(3) wₜ(4) wₜ(5) wₜ(6) wₜ(7)] |
|---|---|---|
| 0 | [+1 +1] | [+1 +1 +1 +1 +1 +1 +1 +1] |
| 1 | [+1 −1] | [+1 +1 +1 +1 +1 +1 +1 +1] |
| 2 | [+1 +1] | [+1 −1 +1 −1 +1 −1 +1 −1] |
| 3 | [+1 −1] | [+1 −1 +1 −1 +1 −1 +1 −1] |
| 4 | [+1 +1] | [+1 +1 −1 −1 +1 +1 −1 −1] |
| 5 | [+1 −1] | [+1 +1 −1 −1 +1 +1 −1 −1] |
| 6 | [+1 +1] | [+1 −1 −1 +1 +1 −1 −1 +1] |
| 7 | [+1 −1] | [+1 −1 −1 +1 +1 −1 −1 +1] |
| 8 | [+1 +1] | [+1 +1 +1 +1 −1 −1 −1 −1] |
| 9 | [+1 −1] | [+1 +1 +1 +1 −1 −1 −1 −1] |
| 10 | [+1 +1] | [+1 −1 +1 −1 −1 +1 −1 +1] |
| 11 | [+1 −1] | [+1 −1 +1 −1 −1 +1 −1 +1] |
| 12 | [+1 +1] | [+1 +1 −1 −1 −1 −1 +1 +1] |
| 13 | [+1 −1] | [+1 +1 −1 −1 −1 −1 +1 +1] |
| 14 | [+1 +1] | [+1 −1 −1 +1 −1 +1 +1 −1] |
| 15 | [+1 −1] | [+1 −1 −1 +1 −1 +1 +1 −1] |

TABLE 27
The sequences w_{f}(k_{q}′) and wₜ(l_{q}′) for
cdm-Type equal to ‘cdm16-FD4-TD4’

| Index | [w_{f}(0) w_{f}(1) w_{f}(2) w_{f}(3)] | [wₜ(0) wₜ(1) wₜ(2) wₜ(3)] |
|---|---|---|
| 0 | [+1 +1 +1 +1] | [+1 +1 +1 +1] |
| 1 | [+1 −1 +1 −1] | [+1 +1 +1 +1] |
| 2 | [+1 +1 −1 −1] | [+1 +1 +1 +1] |
| 3 | [+1 −1 −1 +1] | [+1 +1 +1 +1] |
| 4 | [+1 +1 +1 +1] | [+1 −1 +1 −1] |
| 5 | [+1 −1 +1 −1] | [+1 −1 +1 −1] |
| 6 | [+1 +1 −1 −1] | [+1 −1 +1 −1] |
| 7 | [+1 −1 −1 +1] | [+1 −1 +1 −1] |
| 8 | [+1 +1 +1 +1] | [+1 +1 −1 −1] |
| 9 | [+1 −1 +1 −1] | [+1 +1 −1 −1] |
| 10 | [+1 +1 −1 −1] | [+1 +1 −1 −1] |
| 11 | [+1 −1 −1 +1] | [+1 +1 −1 −1] |
| 12 | [+1 +1 +1 +1] | [+1 −1 −1 +1] |
| 13 | [+1 −1 +1 −1] | [+1 −1 −1 +1] |
| 14 | [+1 +1 −1 −1] | [+1 −1 −1 +1] |
| 15 | [+1 −1 −1 +1] | [+1 −1 −1 +1] |

TABLE 28
The sequences w_{f}(k_{q}′) and wₜ(l_{q}′)
for cdm-Type equalto ‘cdm32-FD4-TD8’

| | | [wₜ(0) wₜ(1) wₜ(2) wₜ(3) wₜ(4) |
|---|---|---|
| Index | [w_{f}(0) w_{f}(1) w_{f}(2) w_{f}(3)] | wₜ(5) wₜ(6) wₜ(7)] |
| 0 | [+1 +1 +1 +1] | [+1 +1 +1 +1 +1 +1 +1 +1] |
| 1 | [+1 −1 +1 −1] | [+1 +1 +1 +1 +1 +1 +1 +1] |
| 2 | [+1 +1 −1 −1] | [+1 +1 +1 +1 +1 +1 +1 +1] |
| 3 | [+1 −1 −1 +1] | [+1 +1 +1 +1 +1 +1 +1 +1] |
| 4 | [+1 +1 +1 +1] | [+1 −1 +1 −1 +1 −1 +1 −1] |
| 5 | [+1 −1 +1 −1] | [+1 −1 +1 −1 +1 −1 +1 −1] |
| 6 | [+1 +1 −1 −1] | [+1 −1 +1 −1 +1 −1 +1 −1] |
| 7 | [+1 −1 −1 +1] | [+1 −1 +1 −1 +1 −1 +1 −1] |
| 8 | [+1 +1 +1 +1] | [+1 +1 −1 −1 +1 +1 −1 −1] |
| 9 | [+1 −1 +1 −1] | [+1 +1 −1 −1 +1 +1 −1 −1] |
| 10 | [+1 +1 −1 −1] | [+1 +1 −1 −1 +1 +1 −1 −1] |
| 11 | [+1 −1 −1 +1] | [+1 +1 −1 −1 +1 +1 −1 −1] |
| 12 | [+1 +1 +1 +1] | [+1 −1 −1 +1 +1 −1 −1 +1] |
| 13 | [+1 −1 +1 −1] | [+1 −1 −1 +1 +1 −1 −1 +1] |
| 14 | [+1 +1 −1 −1] | [+1 −1 −1 +1 +1 −1 −1 +1] |
| 15 | [+1 −1 −1 +1] | [+1 −1 −1 +1 +1 −1 −1 +1] |
| 16 | [+1 +1 +1 +1] | [+1 +1 +1 +1 −1 −1 −1 −1] |
| 17 | [+1 −1 +1 −1] | [+1 +1 +1 +1 −1 −1 −1 −1] |
| 18 | [+1 +1 −1 −1] | [+1 +1 +1 +1 −1 −1 −1 −1] |
| 19 | [+1 −1 −1 +1] | [+1 +1 +1 +1 −1 −1 −1 −1] |
| 20 | [+1 +1 +1 +1] | [+1 −1 +1 −1 −1 +1 −1 +1] |
| 21 | [+1 −1 +1 −1] | [+1 −1 +1 −1 −1 +1 −1 +1] |
| 22 | [+1 +1 −1 −1] | [+1 −1 +1 −1 −1 +1 −1 +1] |
| 23 | [+1 −1 −1 +1] | [+1 −1 +1 −1 −1 +1 −1 +1] |
| 24 | [+1 +1 +1 +1] | [+1 +1 −1 −1 −1 −1 +1 +1] |
| 25 | [+1 −1 +1 −1] | [+1 +1 −1 −1 −1 −1 +1 +1] |
| 26 | [+1 +1 −1 −1] | [+1 +1 −1 −1 −1 −1 +1 +1] |
| 27 | [+1 −1 −1 +1] | [+1 +1 −1 −1 −1 −1 +1 +1] |
| 28 | [+1 +1 +1 +1] | [+1 −1 −1 +1 −1 +1 +1 −1] |
| 29 | [+1 −1 +1 −1] | [+1 −1 −1 +1 −1 +1 +1 −1] |
| 30 | [+1 +1 −1 −1] | [+1 −1 −1 +1 −1 +1 +1 −1] |
| 31 | [+1 −1 −1 +1] | [+1 −1 −1 +1 −1 +1 +1 −1] |

TABLE 29
The sequences w_{f}(k_{q}′) and wₜ(l_{q}′) for
cdm-Type equal to ‘cdm64-FD8-TD8’

| | [w_{f}(0) w_{f}(1) w_{f}(2) w_{f}(3) w_{f}(4) | [wₜ(0) wₜ(1) wₜ(2) wₜ(3) wₜ(4) |
|---|---|---|
| Index | w_{f}(5) w_{f}(6) w_{f}(7)] | wₜ(5) wₜ(6) wₜ(7)] |
| 0 | [+1 +1 +1 +1 +1 +1 +1 +1] | [+1 +1 +1 +1 +1 +1 +1 +1] |
| 1 | [+1 −1 +1 −1 +1 −1 +1 −1] | [+1 +1 +1 +1 +1 +1 +1 +1] |
| 2 | [+1 +1 −1 −1 +1 +1 −1 −1] | [+1 +1 +1 +1 +1 +1 +1 +1] |
| 3 | [+1 −1 −1 +1 +1 −1 −1 +1] | [+1 +1 +1 +1 +1 +1 +1 +1] |
| 4 | [+1 +1 +1 +1 −1 −1 −1 −1] | [+1 +1 +1 +1 +1 +1 +1 +1] |
| 5 | [+1 −1 +1 −1 −1 +1 −1 +1] | [+1 +1 +1 +1 +1 +1 +1 +1] |
| 6 | [+1 +1 −1 −1 −1 −1 +1 +1] | [+1 +1 +1 +1 +1 +1 +1 +1] |
| 7 | [+1 −1 −1 +1 −1 +1 +1 −1] | [+1 +1 +1 +1 +1 +1 +1 +1] |
| 8 | [+1 +1 +1 +1 +1 +1 +1 +1] | [+1 −1 +1 −1 +1 −1 +1 −1] |
| 9 | [+1 −1 +1 −1 +1 −1 +1 −1] | [+1 −1 +1 −1 +1 −1 +1 −1] |
| 10 | [+1 +1 −1 −1 +1 +1 −1 −1] | [+1 −1 +1 −1 +1 −1 +1 −1] |
| 11 | [+1 −1 −1 +1 +1 −1 −1 +1] | [+1 −1 +1 −1 +1 −1 +1 −1] |
| 12 | [+1 +1 +1 +1 −1 −1 −1 −1] | [+1 −1 +1 −1 +1 −1 +1 −1] |
| 13 | [+1 −1 +1 −1 −1 +1 −1 +1] | [+1 −1 +1 −1 +1 −1 +1 −1] |
| 14 | [+1 +1 −1 −1 −1 −1 +1 +1] | [+1 −1 +1 −1 +1 −1 +1 −1] |
| 15 | [+1 −1 −1 +1 −1 +1 +1 −1] | [+1 −1 +1 −1 +1 −1 +1 −1] |
| 16 | [+1 +1 +1 +1 +1 +1 +1 +1] | [+1 +1 −1 −1 +1 +1 −1 −1] |
| 17 | [+1 −1 +1 −1 +1 −1 +1 −1] | [+1 +1 −1 −1 +1 +1 −1 −1] |
| 18 | [+1 +1 −1 −1 +1 +1 −1 −1] | [+1 +1 −1 −1 +1 +1 −1 −1] |
| 19 | [+1 −1 −1 +1 +1 −1 −1 +1] | [+1 +1 −1 −1 +1 +1 −1 −1] |
| 20 | [+1 +1 +1 +1 −1 −1 −1 −1] | [+1 +1 −1 −1 +1 +1 −1 −1] |
| 21 | [+1 −1 +1 −1 −1 +1 −1 +1] | [+1 +1 −1 −1 +1 +1 −1 −1] |
| 22 | [+1 +1 −1 −1 −1 −1 +1 +1] | [+1 +1 −1 −1 +1 +1 −1 −1] |
| 23 | [+1 −1 −1 +1 −1 +1 +1 −1] | [+1 +1 −1 −1 +1 +1 −1 −1] |
| 24 | [+1 +1 +1 +1 +1 +1 +1 +1] | [+1 −1 −1 +1 +1 −1 −1 +1] |
| 25 | [+1 −1 +1 −1 +1 −1 +1 −1] | [+1 −1 −1 +1 +1 −1 −1 +1] |
| 26 | [+1 +1 −1 −1 +1 +1 −1 −1] | [+1 −1 −1 +1 +1 −1 −1 +1] |
| 27 | [+1 −1 −1 +1 +1 −1 −1 +1] | [+1 −1 −1 +1 +1 −1 −1 +1] |
| 28 | [+1 +1 +1 +1 −1 −1 −1 −1] | [+1 −1 −1 +1 +1 −1 −1 +1] |
| 29 | [+1 −1 +1 −1 −1 +1 −1 +1] | [+1 −1 −1 +1 +1 −1 −1 +1] |
| 30 | [+1 +1 −1 −1 −1 −1 +1 +1] | [+1 −1 −1 +1 +1 −1 −1 +1] |
| 31 | [+1 −1 −1 +1 −1 +1 +1 −1] | [+1 −1 −1 +1 +1 −1 −1 +1] |
| 32 | [+1 +1 +1 +1 +1 +1 +1 +1] | [+1 +1 +1 +1 −1 −1 −1 −1] |
| 33 | [+1 −1 +1 −1 +1 −1 +1 −1] | [+1 +1 +1 +1 −1 −1 −1 −1] |
| 34 | [+1 +1 −1 −1 +1 +1 −1 −1] | [+1 +1 +1 +1 −1 −1 −1 −1] |
| 35 | [+1 −1 −1 +1 +1 −1 −1 +1] | [+1 +1 +1 +1 −1 −1 −1 −1] |
| 36 | [+1 +1 +1 +1 −1 −1 −1 −1] | [+1 +1 +1 +1 −1 −1 −1 −1] |
| 37 | [+1 −1 +1 −1 −1 +1 −1 +1] | [+1 +1 +1 +1 −1 −1 −1 −1] |
| 38 | [+1 +1 −1 −1 −1 −1 +1 +1] | [+1 +1 +1 +1 −1 −1 −1 −1] |
| 39 | [+1 −1 −1 +1 −1 +1 +1 −1] | [+1 +1 +1 +1 −1 −1 −1 −1] |
| 40 | [+1 +1 +1 +1 +1 +1 +1 +1] | [+1 −1 +1 −1 −1 +1 −1 +1] |
| 41 | [+1 −1 +1 −1 +1 −1 +1 −1] | [+1 −1 +1 −1 −1 +1 −1 +1] |
| 42 | [+1 +1 −1 −1 +1 +1 −1 −1] | [+1 −1 +1 −1 −1 +1 −1 +1] |
| 43 | [+1 −1 −1 +1 +1 −1 −1 +1] | [+1 −1 +1 −1 −1 +1 −1 +1] |
| 44 | [+1 +1 +1 +1 −1 −1 −1 −1] | [+1 −1 +1 −1 −1 +1 −1 +1] |
| 45 | [+1 −1 +1 −1 −1 +1 −1 +1] | [+1 −1 +1 −1 −1 +1 −1 +1] |
| 46 | [+1 +1 −1 −1 −1 −1 +1 +1] | [+1 −1 +1 −1 −1 +1 −1 +1] |
| 47 | [+1 −1 −1 +1 −1 +1 +1 −1] | [+1 −1 +1 −1 −1 +1 −1 +1] |
| 48 | [+1 +1 +1 +1 +1 +1 +1 +1] | [+1 +1 −1 −1 −1 −1 +1 +1] |
| 49 | [+1 −1 +1 −1 +1 −1 +1 −1] | [+1 +1 −1 −1 −1 −1 +1 +1] |
| 50 | [+1 +1 −1 −1 +1 +1 −1 −1] | [+1 +1 −1 −1 −1 −1 +1 +1] |
| 51 | [+1 −1 −1 +1 +1 −1 −1 +1] | [+1 +1 −1 −1 −1 −1 +1 +1] |
| 52 | [+1 +1 +1 +1 −1 −1 −1 −1] | [+1 +1 −1 −1 −1 −1 +1 +1] |
| 53 | [+1 −1 +1 −1 −1 +1 −1 +1] | [+1 +1 −1 −1 −1 −1 +1 +1] |
| 54 | [+1 +1 −1 −1 −1 −1 +1 +1] | [+1 +1 −1 −1 −1 −1 +1 +1] |
| 55 | [+1 −1 −1 +1 −1 +1 +1 −1] | [+1 +1 −1 −1 −1 −1 +1 +1] |
| 56 | [+1 +1 +1 +1 +1 +1 +1 +1] | [+1 −1 −1 +1 −1 +1 +1 −1] |
| 57 | [+1 −1 +1 −1 +1 −1 +1 −1] | [+1 −1 −1 +1 −1 +1 +1 −1] |
| 58 | [+1 +1 −1 −1 +1 +1 −1 −1] | [+1 −1 −1 +1 −1 +1 +1 −1] |
| 59 | [+1 −1 −1 +1 +1 −1 −1 +1] | [+1 −1 −1 +1 −1 +1 +1 −1] |
| 60 | [+1 +1 +1 +1 −1 −1 −1 −1] | [+1 −1 −1 +1 −1 +1 +1 −1] |
| 61 | [+1 −1 +1 −1 −1 +1 −1 +1] | [+1 −1 −1 +1 −1 +1 +1 −1] |
| 62 | [+1 +1 −1 −1 −1 −1 +1 +1] | [+1 −1 −1 +1 −1 +1 +1 −1] |
| 63 | [+1 −1 −1 +1 −1 +1 +1 −1] | [+1 −1 −1 +1 −1 +1 +1 −1] |

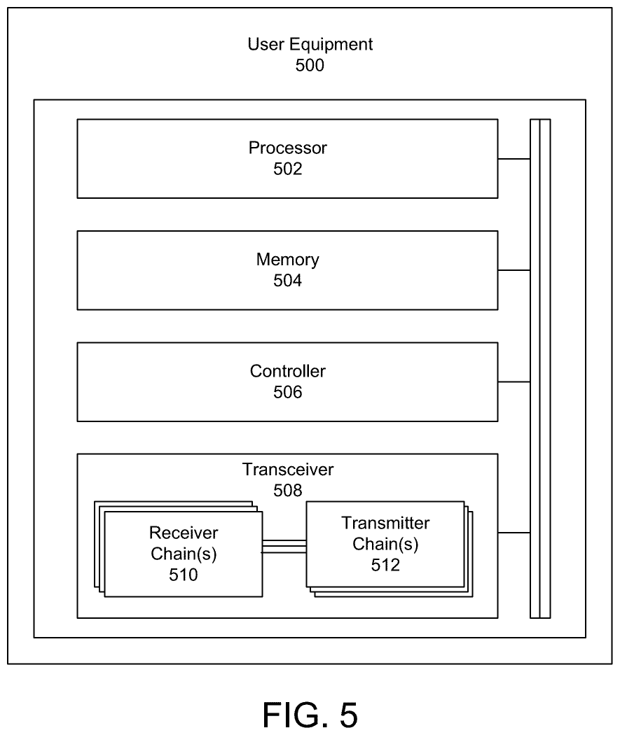

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions that, when executed by the processor 502, cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the UE functions described herein (e.g., executing, by the processor 502, instructions stored in the memory 504). Accordingly, the processor 502 may support wireless communication at the UE 500 in accordance with examples as disclosed herein.

In one example, a UE 500 is configured to receive a CSI-RS resource configuration that configures a CSI-RS resource associated with a quantity of CSI-RS ports greater than a threshold number of ports, identify at least one resource-element location based at least in part on a rule indicated in the CSI-RS resource configuration, wherein the CSI-RS resource configuration indicates fewer than all resource-element locations for the CSI-RS resource, perform one or more CSI measurements based on the identified at least one resource-element location, and transmit a CSI report comprising at least one of the CSI measurements.

In one example, the UE 500 is configured to determine resource-element locations for the CSI-RS resource based at least in part on one or more parameters included in the CSI-RS resource configuration. In one example, the one or more parameters comprise at least one of a frequency-domain allocation, a time-domain allocation, a density indication, and a CDM type indication.

In one example, determining the resource-element locations includes determining anchor resource elements for one or more CDM groups. In one example, determining the resource-element locations comprises selecting a CDM sequence corresponding to a CDM group associated with the CSI-RS resource.

In one example, determining the resource-element locations comprises determining locations for the CSI-RS resource in a multi-RB frequency structure having a density less than one. In one example, determining the resource-element locations comprises determining locations for the CSI-RS resource in a multi-slot time structure.

In one example, the threshold number of ports corresponds to a maximum number of CSI-RS ports in a reference CSI-RS configuration table. In one example, the CSI-RS resource configuration indicates a row of an extended CSI-RS configuration table that defines resource-element locations for at least a portion of the CSI-RS resource.

In one example, identifying the at least one resource-element location comprises deriving resource-element locations for one or more additional CDM groups based on the rule or offset. In one example, the rule comprises a frequency-domain offset or a time-domain offset. In one example, the rule comprises an inter-CDM-group density value.

In one example, the CSI-RS resource configuration indicates a mapping type comprising at least one of frequency-domain mapping, time-domain mapping, or joint frequency-time mapping. In one example, identifying the at least one resource-element location comprises determining resource-element locations for the CSI-RS resource across multiple resource blocks.

In one example, identifying the at least one resource-element location comprises determining resource-element locations for the CSI-RS resource across multiple slots. In one example, identifying the at least one resource-element location comprises applying a time or frequency shift relative to a configured CDM group. In one example, identifying the at least one resource-element location comprises determining the resource-element locations of a plurality of CDM groups based on a single explicitly configured CDM group.

The controller 506 may manage input and output signals for the UE 500. The controller 506 may also manage peripherals not integrated into the UE 500. In some implementations, the controller 506 may utilize an operating system (OS) such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

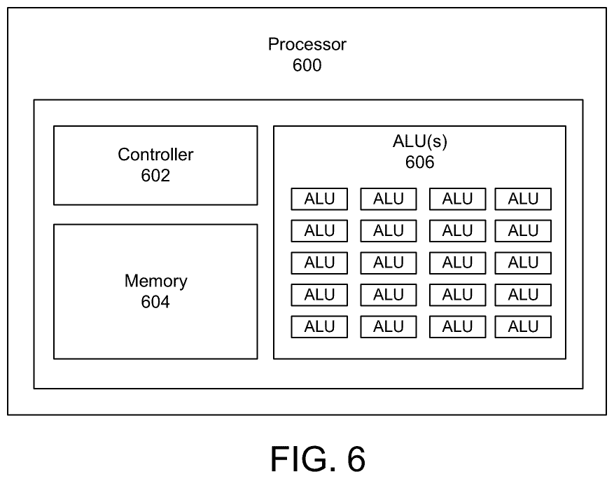

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

In various examples, the processor 600 may support wireless communication of a UE, in accordance with examples as disclosed herein. In other examples, the processor 600 may support wireless communication of a RAN entity, in accordance with examples as disclosed herein.

In one example, the processor 600 is configured to receive a CSI-RS resource configuration that configures a CSI-RS resource associated with a quantity of CSI-RS ports greater than a threshold number of ports, identify at least one resource-element location based at least in part on a rule indicated in the CSI-RS resource configuration, wherein the CSI-RS resource configuration indicates fewer than all resource-element locations for the CSI-RS resource, perform one or more CSI measurements based on the identified at least one resource-element location, and transmit a CSI report comprising at least one of the CSI measurements.

In one example, the processor 600 is configured to determine resource-element locations for the CSI-RS resource based at least in part on one or more parameters included in the CSI-RS resource configuration. In one example, the one or more parameters comprise at least one of a frequency-domain allocation, a time-domain allocation, a density indication, and a CDM type indication.

In one example, determining the resource-element locations includes determining anchor resource elements for one or more CDM groups. In one example, determining the resource-element locations comprises selecting a CDM sequence corresponding to a CDM group associated with the CSI-RS resource.

In one example, determining the resource-element locations comprises determining locations for the CSI-RS resource in a multi-RB frequency structure having a density less than one. In one example, determining the resource-element locations comprises determining locations for the CSI-RS resource in a multi-slot time structure.

In one example, the threshold number of ports corresponds to a maximum number of CSI-RS ports in a reference CSI-RS configuration table. In one example, the CSI-RS resource configuration indicates a row of an extended CSI-RS configuration table that defines resource-element locations for at least a portion of the CSI-RS resource.

In one example, identifying the at least one resource-element location comprises deriving resource-element locations for one or more additional CDM groups based on the rule or offset. In one example, the rule comprises a frequency-domain offset or a time-domain offset. In one example, the rule comprises an inter-CDM-group density value.

In one example, the CSI-RS resource configuration indicates a mapping type comprising at least one of frequency-domain mapping, time-domain mapping, or joint frequency-time mapping. In one example, identifying the at least one resource-element location comprises determining resource-element locations for the CSI-RS resource across multiple resource blocks.

In one example, identifying the at least one resource-element location comprises determining resource-element locations for the CSI-RS resource across multiple slots. In one example, identifying the at least one resource-element location comprises applying a time or frequency shift relative to a configured CDM group. In one example, identifying the at least one resource-element location comprises determining the resource-element locations of a plurality of CDM groups based on a single explicitly configured CDM group.

In one example, the processor 600 is configured to generate a CSI-RS resource configuration that configures a CSI-RS resource associated with a quantity of CSI-RS ports greater than a threshold number of ports, include, in the CSI-RS resource configuration, a rule for identifying at least one resource-element location for the CSI-RS resource, wherein the CSI-RS resource configuration indicates fewer than all resource-element locations for the CSI-RS resource, and transmit the CSI-RS resource configuration for performing CSI measurements based on the CSI-RS resource.

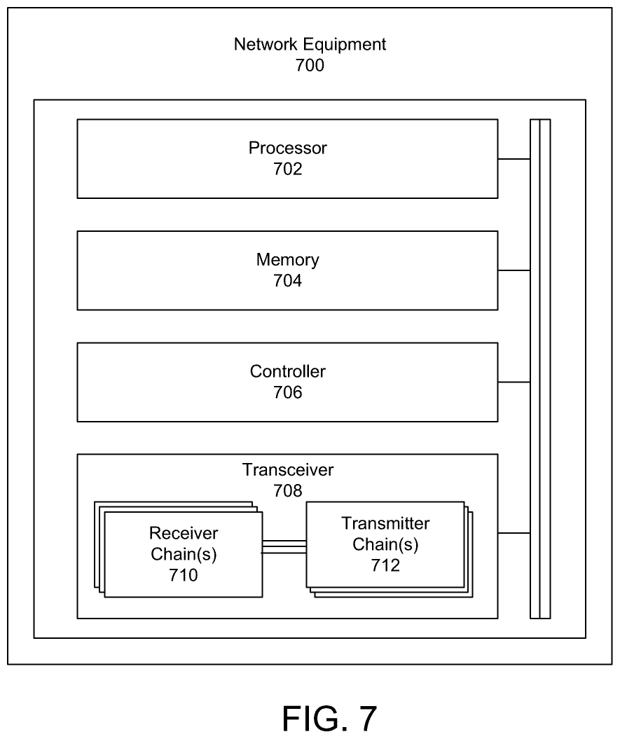

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the RAN functions described herein (e.g., executing, by the processor 702, instructions stored in the memory 704). For example, the processor 702 may support wireless communication at the NE 700 in accordance with examples as disclosed herein.

In one example, the NE 700 is configured to generate a CSI-RS resource configuration that configures a CSI-RS resource associated with a quantity of CSI-RS ports greater than a threshold number of ports, include, in the CSI-RS resource configuration, a rule for identifying at least one resource-element location for the CSI-RS resource, wherein the CSI-RS resource configuration indicates fewer than all resource-element locations for the CSI-RS resource, and transmit the CSI-RS resource configuration for performing CSI measurements based on the CSI-RS resource.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

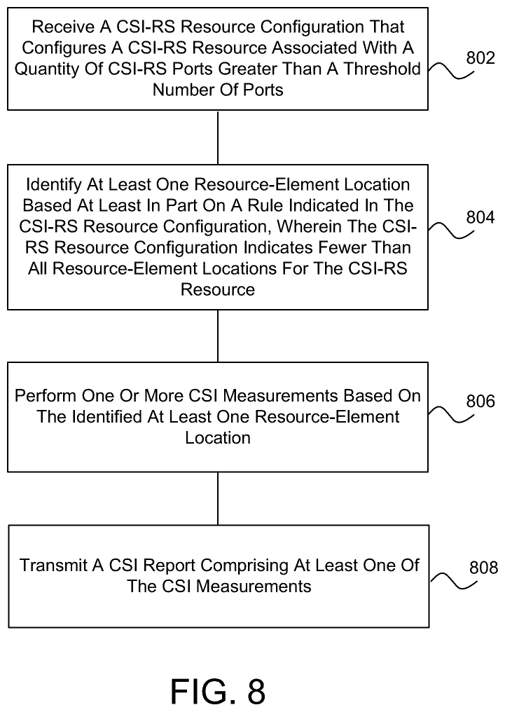

FIG. 8 illustrates a flowchart of a method performed by a UE 500 in accordance with aspects of the present disclosure. The operations of the method may be implemented by a UE 500 as described herein. In some implementations, the UE 500 may execute a set of instructions to control the function elements of the UE 500 to perform the described functions.

At step 802, the method may receive a CSI-RS resource configuration that configures a CSI-RS resource associated with a quantity of CSI-RS ports greater than a threshold number of ports. The operations of step 802 may be performed in accordance with examples as described herein. In some implementations, aspects of the operations of step 802 may be performed by a UE 500, as described with reference to FIG. 5.

At step 804, the method may identify at least one resource-element location based at least in part on a rule indicated in the CSI-RS resource configuration, wherein the CSI-RS resource configuration indicates fewer than all resource-element locations for the CSI-RS resource. The operations of step 804 may be performed in accordance with examples as described herein. In some implementations, aspects of the operations of step 804 may be performed by a UE 500, as described with reference to FIG. 5.

At step 806, the method may perform one or more CSI measurements based on the identified at least one resource-element location. The operations of step 806 may be performed in accordance with examples as described herein. In some implementations, aspects of the operations of step 806 may be performed by a UE 500, as described with reference to FIG. 5.

At step 808, the method may transmit a CSI report comprising at least one of the CSI measurements. The operations of step 808 may be performed in accordance with examples as described herein. In some implementations, aspects of the operations of step 808 may be performed by a UE 500, as described with reference to FIG. 5.

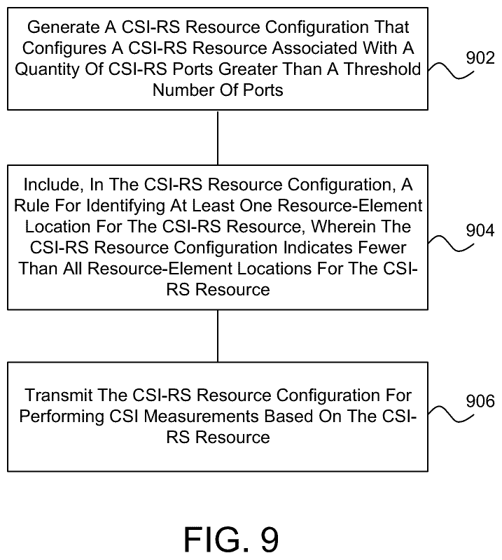

FIG. 9 illustrates a flowchart of a method performed by an NE 700 in accordance with aspects of the present disclosure. The operations of the method may be implemented by an NE 700 as described herein. In some implementations, the NE 700 may execute a set of instructions to control the function elements of the NE 700 to perform the described functions.

At step 902, the method may generate a CSI-RS resource configuration that configures a CSI-RS resource associated with a quantity of CSI-RS ports greater than a threshold number of ports. The operations of step 902 may be performed in accordance with examples as described herein. In some implementations, aspects of the operations of step 902 may be performed by an NE 700, as described with reference to FIG. 7.

At step 904, the method may include, in the CSI-RS resource configuration, a rule for identifying at least one resource-element location for the CSI-RS resource, wherein the CSI-RS resource configuration indicates fewer than all resource-element locations for the CSI-RS resource. The operations of step 904 may be performed in accordance with examples as described herein. In some implementations, aspects of the operations of step 904 may be performed by an NE 700, as described with reference to FIG. 7.

At step 906, the method may transmit the CSI-RS resource configuration for performing CSI measurements based on the CSI-RS resource. The operations of step 906 may be performed in accordance with examples as described herein. In some implementations, aspects of the operations of step 906 may be performed by an NE 700, as described with reference to FIG. 7.

It should be noted that the method described herein describes one possible implementation, and that the operations and the steps may be rearranged or otherwise modified and that other implementations are possible.

As used herein, a CSI-RS resource refers to a NZP or ZP CSI-RS configuration that specifies RE locations, ports, time-domain positions, and frequency-domain positions for CSI measurement. A CSI-RS resource set refers to a group of one or more CSI-RS resources configured for a UE. A reference CSI-RS resource refers to a CSI-RS resource whose RE locations, CDM-group anchor locations, or mapping parameters are explicitly configured by higher-layer signaling and are used as a basis for determining additional CSI-RS resources. An implicitly determined CSI-RS resource refers to a CSI-RS resource or portion thereof whose RE locations or CDM-group mappings are derived by the UE based on one or more reference CSI-RS resources, a mapping type, and one or more offset or density parameters.

A CDM group refers to a set of CSI-RS ports that share a common time-frequency RE structure and corresponding orthogonal CDM sequence, and a CDM type refers to the mapping and sequence pattern applied to ports within a CDM group (e.g., noCDM, fd-CDM2, cdm4-FD2-TD2, cdm8-FD2-TD4, cdm16-FD2-TD8, cdm16-FD4-TD4, cdm32-FD4-TD8, or cdm64-FD8-TD8). A mapping type refers to the manner in which RE locations for implicitly determined CDM groups are derived and may include frequency-domain mapping (FD-mapping), time-domain mapping (TD-mapping), or combined frequency-time mapping (FD-TD mapping). A frequency offset or density parameter ρ_{f} refers to a value that determines the frequency-domain separation between CDM groups, and a time offset or density parameter ρₜ refers to a value that determines the time-domain separation between CDM groups. Unless stated otherwise, terms such as slot, symbol, RB, PRB, BWP, and related numerology follow conventional usage in 3GPP NR specifications.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a channel state information reference signal (CSI-RS) resource configuration that configures a CSI-RS resource associated with a quantity of CSI-RS ports greater than a threshold number of ports;
identify at least one resource-element location based at least in part on a rule indicated in the CSI-RS resource configuration, wherein the CSI-RS resource configuration indicates fewer than all resource-element locations for the CSI-RS resource;
perform one or more CSI measurements based on the identified at least one resource-element location; and
transmit a CSI report comprising at least one of the CSI measurements.

2. The UE of claim 1, wherein the at least one processor is configured to cause the UE to determine resource-element locations for the CSI-RS resource based at least in part on one or more parameters included in the CSI-RS resource configuration.

3. The UE of claim 2, wherein the one or more parameters comprise at least one of a frequency-domain allocation, a time-domain allocation, a density indication, and a code-domain multiplexing (CDM) type indication.

4. The UE of claim 2, wherein determining the resource-element locations includes determining anchor resource elements for one or more code-domain multiplexing (CDM) groups.

5. The UE of claim 2, wherein determining the resource-element locations comprises selecting a code-domain multiplexing (CDM) sequence corresponding to a CDM group associated with the CSI-RS resource.

6. The UE of claim 2, wherein determining the resource-element locations comprises determining locations for the CSI-RS resource in a multi-resource block (RB) frequency structure having a density less than one.

7. The UE of claim 2, wherein determining the resource-element locations comprises determining locations for the CSI-RS resource in a multi-slot time structure.

8. The UE of claim 1, wherein the threshold number of ports corresponds to a maximum number of CSI-RS ports in a reference CSI-RS configuration table.

9. The UE of claim 1, wherein the CSI-RS resource configuration indicates a row of an extended CSI-RS configuration table that defines resource-element locations for at least a portion of the CSI-RS resource.

10. The UE of claim 1, wherein identifying the at least one resource-element location comprises deriving resource-element locations for one or more additional code-domain multiplexing (CDM) groups based on the rule or offset.

11. The UE of claim 1, wherein the rule comprises a frequency-domain offset or a time-domain offset.

12. The UE of claim 1, wherein the rule comprises an inter-code-domain multiplexing (CDM)-group density value.

13. The UE of claim 1, wherein the CSI-RS resource configuration indicates a mapping type comprising at least one of frequency-domain mapping, time-domain mapping, or joint frequency-time mapping.

14. The UE of claim 1, wherein identifying the at least one resource-element location comprises determining resource-element locations for the CSI-RS resource across multiple resource blocks.

15. The UE of claim 1, wherein identifying the at least one resource-element location comprises determining resource-element locations for the CSI-RS resource across multiple slots.

16. The UE of claim 1, wherein identifying the at least one resource-element location comprises applying a time or frequency shift relative to a configured code-domain multiplexing (CDM) group.

17. The UE of claim 1, wherein identifying the at least one resource-element location comprises determining the resource-element locations of a plurality of code-domain multiplexing (CDM) groups based on a single explicitly configured CDM group.

18. A method of a user equipment (UE), comprising:
receiving a channel state information reference signal (CSI-RS) resource configuration that configures a CSI-RS resource associated with a quantity of CSI-RS ports greater than a threshold number of ports;
identifying at least one resource-element location based at least in part on a rule indicated in the CSI-RS resource configuration, wherein the CSI-RS resource configuration indicates fewer than all resource-element locations for the CSI-RS resource;
performing one or more CSI measurements based on the identified at least one resource-element location; and
transmitting a CSI report comprising at least one of the CSI measurements.

19. A network equipment (NE) for wireless communication, comprising:
at least one memory; and
at least one processor coupled with the at least one memory and configured to cause the NE to:
generate a channel state information reference signal (CSI-RS) resource configuration that configures a CSI-RS resource associated with a quantity of CSI-RS ports greater than a threshold number of ports;
include, in the CSI-RS resource configuration, a rule for identifying at least one resource-element location for the CSI-RS resource, wherein the CSI-RS resource configuration indicates fewer than all resource-element locations for the CSI-RS resource; and
transmit the CSI-RS resource configuration for performing CSI measurements based on the CSI-RS resource.

20. A method of a network equipment (NE), comprising:
generating a channel state information reference signal (CSI-RS) resource configuration that configures a CSI-RS resource associated with a quantity of CSI-RS ports greater than a threshold number of ports;
including, in the CSI-RS resource configuration, a rule for identifying at least one resource-element location for the CSI-RS resource, wherein the CSI-RS resource configuration indicates fewer than all resource-element locations for the CSI-RS resource; and
transmitting the CSI-RS resource configuration for performing CSI measurements based on the CSI-RS resource.
